(19) United States
(12) Patent Application Publication
(10) Pub. No.: US 2012/0203610 A1
(43) Pub. Date: Aug. 9, 2012

(54) PAYMENT USING AN EMULATED ELECTRONIC COUPON IN A CONTACTLESS PAYMENT ENVIRONMENT

(76) Inventors: David M. Grigg, Rock Hill, SC (US); Alicia C. Jones, Fort Mill, SC (US); Marc B. Keller, Charlotte, NC (US); Patrick B. Kelly, Charlotte, NC (US)

(21) Appl. No.: 13/023,340

(22) Filed: Feb. 8, 2011

(51) Int. Cl. G06Q 30/00

(52) U.S. Cl. 705/14.23; 705/1.1

(57) ABSTRACT

Embodiments of the invention are directed to apparatus, methods, and computer program products for making a payment at a contactless payment terminal using an electronic coupon emulated as an electronic gift card. In one embodiment, a mobile device emulates electronic coupon data associated with an electronic coupon as electronic gift card data, and transmits this emulated coupon data to a contactless payment terminal that has the ability to read and processes electronic gift card data. Therefore, the invention may permit a user to make a payment using an electronic coupon at a contactless payment terminal that is not configured to read the native data format of the electronic coupon.

### CROSS-REFERENCE TO RELATED APPLICATION

This application claims priority to U.S. Provisional Application No. ______, titled “Payment Using an Emulated Electronic Coupon in a Contactless Payment Environment” and filed on Jan. 31, 2011 (which was converted from Non-Provisional Application No. 13/018,280 by a petition filed Feb. 8, 2011), the entire disclosure of which is incorporated herein by reference.

### BACKGROUND

A contactless payment is a payment where a customer pays a purchase amount without handing a payment card or a payment device to a cashier at the point-of-sale (POS) and without swiping the magnetic stripe of a payment card through a payment terminal (also sometimes referred to as a POS terminal). In other words, a contactless payment is one made using a payment device that wirelessly transmits payment information to the payment terminal. Although physical contact between the payment device and the payment terminal may still occur in a contactless payment environment, physical contact between the payment device and the payment terminal is not necessary for transmission of the payment information from the payment device to the payment terminal.

Contactless payment terminals have the ability to read and process electronic payment information, such as credit or debit card information, received wirelessly from a mobile device (e.g., a cell phone or other handheld computer) that is brought close to the contactless payment terminal. Contactless payment terminals may also have the ability to read and process electronic gift card information received from a mobile device that is brought close to the contactless payment terminal. However, contactless payment terminals may not have the ability to read and process electronic coupon information received from a mobile device that is brought close to the contactless payment terminal.

Gift cards are fundamentally different from coupons. A gift card is a card, or electronic equivalent, of monetary value that may be purchased by a customer from an entity. The monetary value of the gift card or its electronic equivalent may be redeemed, in most cases, for purchases made at the entity, while abiding by certain restrictions imposed by the entity. Therefore, a gift card is essentially a payment vehicle for making purchases. As used herein, a payment vehicle is a payment instrument such as a credit account, debit account, bank card, or other instrument that can be used by one entity to pay another entity.

Unlike a gift card, a coupon typically is not purchased by a customer. Moreover, unlike a gift card, a coupon typically is not a payment vehicle that may be used by itself for paying an entire purchase amount. A coupon is a ticket, or electronic equivalent, that may be exchanged for a discount on a purchase amount of one or more purchased items. The remaining purchase amount may be paid for using a payment vehicle, such as a gift card, credit card, debit card, electronic equivalents of these “cards”, or the like.

Many entities provide customers and potential customers with coupons to entice them to purchase goods from the entity or to reward customers for loyalty to the entity. Therefore, many entities would like to allow its customers to use electronic coupons at contactless payment terminals, especially those customers who would otherwise go elsewhere to make the same or a similar purchase. Moreover, an entity would like to allow their customers to use coupons without having to upgrade the entity's contactless payment terminals. Unfortunately, many payment terminals are only configured to receive and process information from mobile devices that pertain to electronic credit cards, debit cards, and gift cards, and are not configured to receive information about or process electronic coupons. Therefore, for all these reasons and others, there is a need for a mobile wallet system that allows a user to hold electronic coupons in a mobile device and have them be readable and processable by a contactless payment terminal that may not be separately configured to wirelessly receive electronic coupon information from a mobile device.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention solve the problem described above and/or other problems by providing systems, methods and computer program products for making and receiving payments at a contactless payment terminal using an electronic coupon that is emulated as an electronic gift card. More specifically, one embodiment of the invention provides a mobile wallet application installed on a mobile device, where the mobile device is configured to wirelessly communicate payment information to a payment terminal. The mobile wallet application is configured to help the user manage payment information stored on the mobile device and help the user to communicate payment information to the payment terminal using the correct protocol or data format. In an embodiment of the invention, the mobile wallet application, when executed by the processor of the mobile device, typically presents the user with a graphical user interface (GUI) that allows the user to select a payment vehicle to use for a transaction from a plurality of payment vehicles stored in the mobile device. In one embodiment of the invention, the mobile wallet application presents a GUI that displays electronic coupons to the user that the user has downloaded onto the mobile device from a coupon server. The GUI displays these electronic coupons to the user as coupons. However, when a user desires to use one of these coupons during a transaction, the mobile device communicates these electronic coupons to the payment terminal using a gift card data format (i.e., an existing electronic gift card transmission protocol in which the payment terminal is already configured to communicate).

Such an invention is useful in contactless payment environments where the payment terminal is not configured to receive coupon data formats, but is configured to receive gift card data formats. Currently, this is the case for many payment terminals and, as such, embodiments of the invention may allow the use of electronic coupons without the need to modify the payment terminal infrastructure to receive and process a new coupon data format.

As described in greater detail below, in some embodiments of the invention, the mobile device receives the coupon from a coupon server in a coupon data format and converts the coupon into a gift card data format for communication to the payment terminal. In other embodiments, however, the coupon server creates the coupons using a gift card data format and communicates the coupons to the mobile device where they are stored in a gift card format, but displayed to the user via the GUI as a coupon instead of as a gift card.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a flow chart illustrating a method of making a payment using an electronic coupon at a contactless payment terminal via a mobile device, in accordance with an embodiment of the invention;

FIG. 2 provides a flow chart illustrating a two “tap” process for making a payment using an electronic coupon at a contactless payment terminal via a mobile device configured to emulate coupon data using a gift card data format, in accordance with an embodiment of the invention;

FIG. 3 provides a flow chart illustrating a single “tap” process for making a payment using an electronic coupon at a contactless payment terminal via a mobile device configured to emulate coupon data using a gift card data format, in accordance with an embodiment of the invention;

FIG. 4 provides a flow chart illustrating a process for making a payment using an electronic coupon at a contactless payment terminal via a mobile device where the coupon server sends the coupon data to the mobile device in a gift card data format, in accordance with an embodiment of the invention;

FIG. 5 provides a block diagram illustrating a contactless payment environment, in accordance with an embodiment of the invention;

FIG. 6 provides a block diagram illustrating the mobile device of FIG. 5, in accordance with an embodiment of the invention;

FIG. 7 provides a block diagram illustrating the contactless payment terminal of FIG. 5, in accordance with an embodiment of the invention;

FIG. 8 provides a block diagram illustrating the coupon server of FIG. 5, in accordance with an embodiment of the invention;

FIG. 9 provides a block diagram illustrating a gift card data packet structure, in accordance with an embodiment of the invention;

FIG. 10 provides a block diagram illustrating a payment vehicle data packet structure, in accordance with an embodiment of the invention; and

FIG. 11 provides a block diagram illustrating a single “tap” data packet structure, in accordance with an embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In accordance with embodiments of the invention, the term “entity” may refer to a seller, merchant, or the like, that offers contactless payment as a method of paying for a purchase associated with the entity. In accordance with embodiments of the invention, the term “user” may refer to a customer or the like, who makes a payment at a contactless payment terminal associated with an entity.

In accordance with embodiments of the invention, the term “tapping” may refer to bringing a mobile device close to or within the proximity of a contactless payment terminal so that information can be communicated wirelessly between the mobile device and the contactless payment terminal using short range wireless transmission technology, such near-field communication (NFC) technology, radio-frequency (RF) technology, or the like. Tapping may include physically tapping the mobile device against an appropriate portion of the payment terminal or it may include only waving or holding the mobile device near an appropriate portion of the payment terminal without making physical contact with the payment terminal.

In accordance with embodiments of the invention, the term “coupon” may refer to an electronic coupon. The coupon may include a monetary discount when certain conditions are met (e.g., $1 off purchase of particular product or brand, $10 off any purchase over $100, etc.), a percentage discount when certain conditions are met (e.g., 10% off purchase of particular product or brand, 20% off any purchase from a particular entity, etc.), or some other reward conditioned on an aspect of a purchase (e.g., buy one get one free, etc.). In accordance with embodiments of the invention, the phrase “gift card” may refer to an electronic gift card. In accordance with embodiments of the invention, the term “payment vehicle” may refer to an electronic payment vehicle, such as an electronic credit or debit card. A payment vehicle may not be a “card” at all and may instead be account identifying information stored electronically in a mobile device, such as in a cell phone.

In accordance with embodiments of the invention, the term “module” with respect to a mobile device may refer to a hardware component of a mobile device, a software component of a mobile device, or a component of a mobile device that comprises both hardware and software. In accordance with embodiments of the invention, the term “chip” may refer to an integrated circuit, a microprocessor, a system-on-a-chip, a microcontroller, or the like that may either be integrated into the mobile device or may be inserted and removed from the mobile device by a user. In accordance with embodiments of the invention, the phrase “mobile wallet” may refer to the hardware and/or software in a mobile device that enables the mobile device to be used to make contactless payments at a payment terminal.

In general, embodiments of the present invention relate to systems, methods and computer program products for making and receiving payment at a contactless payment terminal using an electronic coupon that is emulated as an electronic gift card. More specifically, one embodiment of the invention provides a mobile wallet application installed on a mobile device, where the mobile device is configured to wirelessly communicate payment information to a payment terminal. The mobile wallet application is configured to help the user manage payment information stored on the mobile device and help the user to communicate payment information to the payment terminal using the correct protocol or data format. The mobile wallet application, when executed by the processor of the mobile device, typically presents the user with a graphical user interface (GUI) that allows the user to select a payment vehicle to use for a transaction from a plurality of payment vehicles stored in the mobile device. The GUI may also allow the user to set certain payment preferences or mobile wallet preferences. In one embodiment of the invention, the mobile wallet application may also present a GUI that displays electronic coupons to the user that the user has downloaded onto the mobile device from a coupon server. The GUI displays these electronic coupons to the user as coupons. However, in accordance with embodiments of the invention, when a user desires to use a coupon stored in the mobile device during a transaction, the mobile device communicates these electronic coupons to the payment terminal using a gift card data format (i.e., an existing electronic gift card transmission protocol which the payment terminal is already configured to receive and process).

Such an invention is useful in contactless payment environments where the payment terminal is not configured to receive coupon data formats, but is configured to receive gift card data formats. Currently, this is the case for many payment terminals and, as such, embodiments of the invention may allow the use of electronic coupons without the need to modify the payment terminal infrastructure to receive and process a new coupon data format.

In some embodiments of the invention, the mobile device receives the coupon from a coupon server in a coupon data format. Then, prior to or during transmission of the electronic coupon to the payment terminal, the mobile wallet application converts the coupon data format to a gift card data format.

In other embodiments of the invention, the coupon server creates a coupon using a gift card data format and then presents the coupon to the user when the user accesses the coupon via the user's mobile device. The user then downloads the coupon from the coupon server to the mobile device in the gift card data format. The mobile device then transmits the coupon to the payment terminal in the gift card data format in which the coupon was downloaded.

### Process Overview

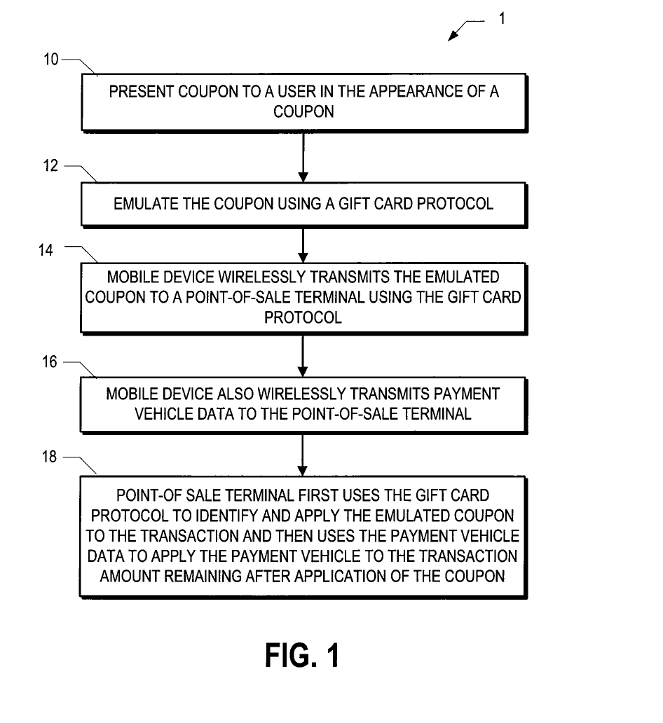

Referring to FIG. 1, a flow chart is provided illustrating a method 1 of making a payment using an electronic coupon at a contactless payment terminal via a mobile device, in accordance with an embodiment of the invention. As illustrated by block 10, a device presents an electronic coupon to a user, the electronic coupon having the appearance of a typical coupon. As illustrated by block 12, the device emulates the coupon using a gift card data protocol. As illustrated by block 14, a mobile device (which may or may not be the same device that performed the procedures represented by blocks 10 and 12) wirelessly transmits the emulated coupon to a point-of-sale (POS) terminal using the gift card protocol. As illustrated by block 16, the mobile device also wirelessly transmits payment vehicle data to the POS terminal. As represented by block 18, the POS terminal then first uses the gift card protocol to identify the emulated coupon from the gift card data and apply the emulated coupon to the transaction. The POS terminal then uses payment vehicle protocol to identify the payment vehicle from the payment vehicle data and apply the payment vehicle to the transaction amount remaining after application of the coupon.

For example, in one embodiment of the invention, the electronic coupon is stored on the user's mobile phone in a coupon data format, which may be any format other than the gift card data format. In such an embodiment, the mobile device is also configured to display the electronic coupon to the user as a coupon. However, when the user attempts to the use the coupon at a POS terminal, the mobile device converts the coupon from the coupon data format into the gift card data format for transmission to the POS terminal using the gift card data format. The mobile device also transmits information about a payment vehicle, such as a credit or debit card, to the POS terminal and the POS terminal uses the gift card data to first apply the coupon to the transaction and then uses the payment vehicle data to pay for the transaction amount remaining after the coupon is applied.

In another embodiment of the invention, the electronic coupon is stored on a coupon server that the user accesses using a mobile device or other computing device and it is the coupon server that presents the coupon to the user via, for example, a web page or other graphical user interface. In some embodiments of the invention, the coupon server transmits the electronic coupon to the mobile device using a gift card data protocol and then the mobile device stores the electronic coupon using the gift card data protocol. However, the mobile device may be configured to still display the electronic coupon to the user as a coupon, even though the electronic coupon is stored in the mobile device in a gift card data format. When the user attempts to use the coupon at a POS terminal, the mobile device transmits the coupon to the POS terminal using the gift card data format. The mobile device also transmits information about a payment vehicle, such as a credit or debit card, to the POS terminal and the POS terminal uses the gift card data to first apply the coupon to the transaction and then uses the payment vehicle data to pay for the transaction amount remaining after the coupon is applied

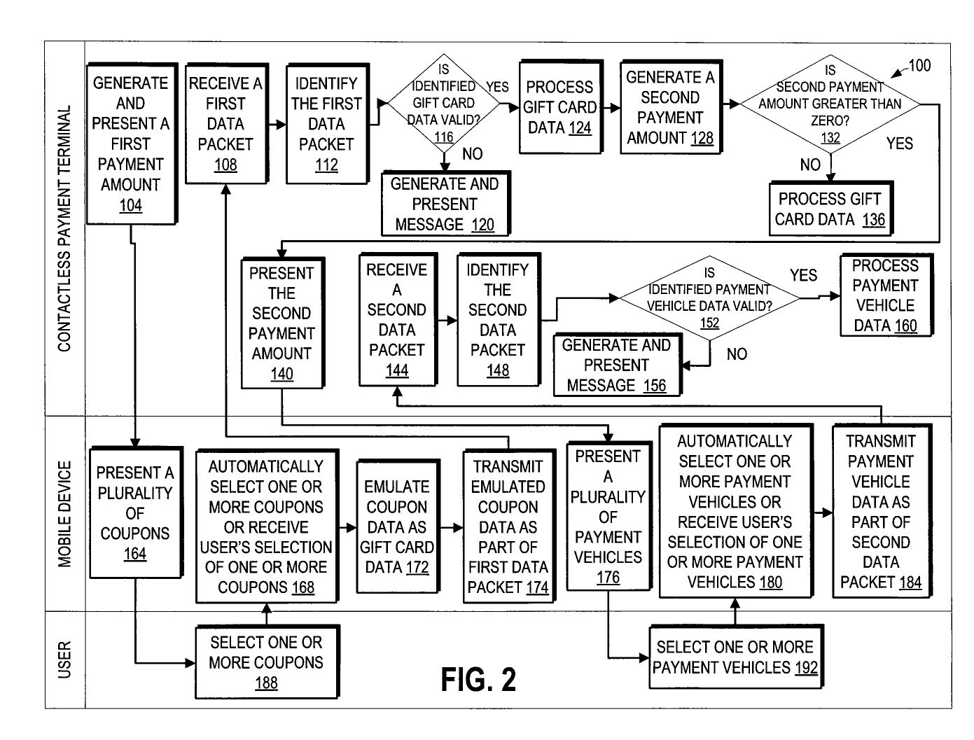

It will be appreciated that, although some embodiments of the method 1 perform the steps in the order illustrated in FIG. 1, other embodiments of the invention may perform one or more of these steps in a different order or simultaneously. The same can be said for the methods illustrated by other flow charts provided herein. The systems and methods that make up these and other embodiments of the invention are described in greater detail below with reference to FIGS. 2-11.

### Two “Tap” Contactless Payment Process Flow

FIG. 2 provides a flow chart illustrating a two “tap” process 100 for making a payment using an electronic coupon at a contactless payment terminal via a mobile device, in accordance with an embodiment of the invention. FIG. 2 illustrates the flow chart in terms of “swim lanes” associated with entities which may perform the operations in each respective swim lane. The entities illustrated in the figure include: (1) a contactless payment terminal; (2) a mobile device; and (3) a user making a payment at a contactless payment terminal via a mobile device. However, it should be noted that other entities could also be involved and that some embodiments of the invention may not be limited to the entities illustrated in FIG. 2. For example, in some embodiments of the invention, a coupon server downloads electronic coupons to the mobile device. Additionally, it should be understood that, in other embodiments of the invention, the entities need not be required to perform the actions illustrated in each respective swim lane. For example, in some embodiments of the invention, one or more of the process steps described herein may be performed by an entity other than the one shown in the swim lane.

In the illustrated embodiment of the invention, the process flow 100 may begin at block 104 of FIG. 2 where the contactless payment terminal generates and presents a first payment amount to the user. For instance, at a fast food restaurant, the contactless payment terminal may generate and present an amount of “$5” for a purchase.

The process moves to block 164 where the mobile device may present a plurality of coupons to the user. In one embodiment, the mobile device may dynamically access the plurality of coupons from a remote coupon server and present these coupons to the user. In another embodiment, the mobile device may access a plurality of coupons that are stored locally on the mobile device (which may have been downloaded by the user from a coupon server at an earlier point in time). In still another embodiment, the mobile device may store the plurality of coupons that were either previously download by the user or automatically downloaded by the mobile device. In one embodiment, the mobile device presents the coupons to the user via a GUI that displays the coupons to the user on the screen of the mobile device and displays them in the form of a coupon. For example, the electronic coupons may be displayed by the mobile device under the heading of “coupons” or in a coupon section of a mobile wallet GUI.

The process moves to block 188 where the user selects a presented coupon on the mobile device. For instance, in one embodiment where the user makes a purchase at a fast food restaurant, the user may select a “$2 off” coupon for that particular fast food restaurant. In another embodiment, the user may select multiple coupons. Therefore, if the restaurant allows a user to stack multiple coupons, the user may, for instance, select a “$2 off” coupon along with a “$1 off” coupon.

The process then moves to block 168 where the mobile device receives the user's selection of one or more coupons. In one embodiment, the mobile device may automatically select one or more coupons without presenting the one or more coupons to the user and without allowing the user to select one or more coupons. The process of automatically selecting a coupon by a mobile device may be based on a pre-determined algorithm that takes into account various parameters including the place of purchase, the type of purchase, the amount of the purchase, whether a coupon has been used previously, or the like. For instance, in one instance, when the user makes a purchase at a fast food restaurant, the mobile device may identify the place of purchase and the type of purchase made by the user, and may automatically select one or more coupons that produces the maximum benefit, which, in most cases, produces the biggest discount to the user. In one instance, the mobile device may identify the type of purchase made by the user by communicating with the contactless payment terminal, as described below, when the mobile device is held close to or “taps” the contactless payment terminal. In another embodiment, the mobile device or a remote server in communication with the mobile device may be configured to identify the place of purchase using global positioning system capabilities of the mobile device. In still another embodiment, the user may enter input into the mobile device to indicate to the mobile device the type of purchase, place of purchase, etc. For instance, the user may input into the mobile device the entity from which the user made a purchase (e.g., a fast food restaurant) along with the type of purchase (e.g., a cheeseburger meal), and subsequently, the mobile device may automatically select the one or more coupons that produces the maximum benefit to the user. As stated earlier, the coupons that may produce the maximum benefit to the user are usually those that result in the largest discount.

The process then moves to block 172 where the mobile device emulates the coupon data for the selected coupon as gift card data. The mobile device must transmit data to the contactless payment terminal in a format that is readable and processable by the contactless payment terminal; otherwise, the user may not be able to make a contactless payment via a mobile device. In some embodiments, the contactless payment terminal may not be able to read and process coupon data. Therefore, in such embodiments, the mobile device is configured to transmit the coupon using a gift card data format, rather than a coupon data format, because gift card data is readable and processable by a contactless payment terminal.

In order to transmit gift card data rather than coupon data, the mobile device may comprise an emulation module that encodes the coupon data based on a gift card protocol such that the effect of selecting a coupon on the mobile device and “tapping” the mobile device near the contactless payment terminal produces a result where the contactless payment terminal receives a coupon as a gift card. Therefore, while a user perceives that a coupon has been transmitted from the mobile device to the contactless payment terminal, the contactless payment terminal may receive a gift card that is readable and processable by the contactless payment terminal. Since gift cards are readable and processable by current contactless payment terminals, there may not be any necessity to implement hardware or software modifications at the contactless payment terminal.

For example, in one embodiment, the gift card data protocol is the “MIFARE” protocol known in the art or a variant of “MIFARE” protocol. In other embodiments, the gift card data protocol may be some other protocol.

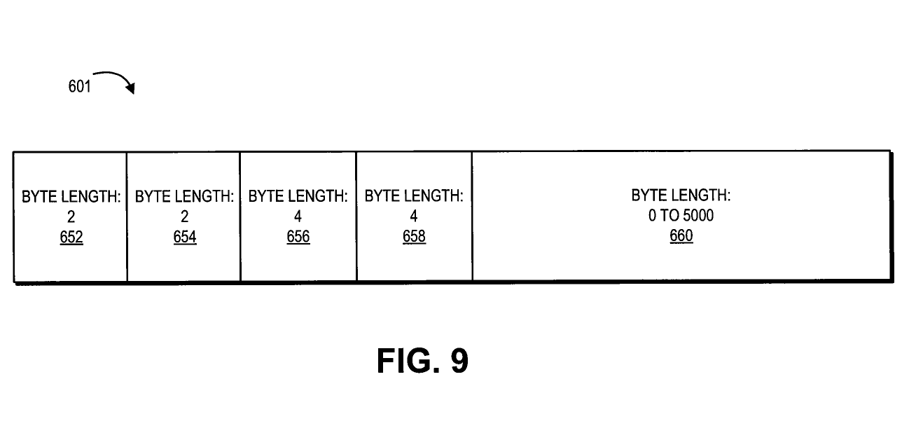

Data is transmitted from the mobile device to the contactless payment terminal via a plurality of data packets. Each data packet has a pre-determined structure or protocol so that the contactless payment terminal may identify the type of data received based on the structure of the data packet. In one embodiment, the gift card data packet protocol, i.e., the gift card data packet structure that the contactless payment terminal recognizes as gift card data, may be represented by the data structure 601 shown in FIG. 9. In this Figure, block 652 may represent the bytes that carry information regarding the address of the source, i.e., the mobile device. Block 654 may represent the bytes that carry information regarding the address of the destination, i.e., the contactless payment terminal. Block 656 may represent the bytes that carry information which may be used to determine whether there were any transmission errors that corrupted the data transmitted from the mobile device. Block 658 may represent the bytes that identify the type of data being sent in block 660, e.g., gift card data, credit card data, debit card data, or the like. In one embodiment, the emulation module in the mobile device may code the bytes carried in block 658 to indicate that gift card data is carried in block 660. Block 660 may represent the bytes that carry the emulated coupon data from the mobile device to the contactless payment terminal. When the contactless payment terminal receives the data packet, the contactless payment terminal may extract what it perceives as gift card data from block 660.

FIG. 9 merely serves as one instance of a gift card data structure. In other embodiments, the gift card data structure may be different from that depicted in FIG. 9. For instance, in another embodiment, the gift card data structure may not include block 658 which carries the bytes that identify the type of data being sent from the mobile device. In such an embodiment, the contactless payment terminal may algorithmically identify the type of data that it received as gift card data by directly decoding the data that is carried in block 660 of the data packet structure.

In one embodiment, the emulation module that encodes the emulated coupon data based on gift card data protocol at the mobile device may be implemented in software only. In the software-only emulation module, a software routine may be used to encode the emulated coupon data into the gift card data packet structure shown in FIG. 9 or another gift card data packet structure. In another embodiment, the emulation module at the mobile device may be implemented using both hardware and software components.

In one embodiment, the emulation module may dynamically emulate the coupon data as gift card data in real-time after the user selects the coupon. In another embodiment, the emulation module may emulate the coupon data for a plurality of coupons stored locally or remotely, and may store the emulated coupon data either locally or remotely.

In one embodiment, the mobile device subsequently instructs the user to “tap” (e.g., wave or hold) the mobile device in close proximity to the contactless payment terminal.

Referring again to FIG. 2, the process then moves to block 174 where the mobile device transmits the emulated coupon data as part of a first data packet to the contactless payment terminal. Block 174 comprises the first “tap” of the two “tap” process flow.

The mobile device transmits the first data packet via any of a number of near field communication (NFC) techniques. In one embodiment, the mobile device transmits data packets via radio frequency electromagnetic waves emanating from the mobile device's transmitting antenna when the mobile device is “tapped” (e.g., held or waved) in close proximity to the contactless payment terminal. When the mobile device's transmitting antenna and the contactless payment terminal's receiving antenna are located in each other's electromagnetic field, they may effectively form a transformer and data packets are transmitted from the mobile device to the contactless payment terminal via electromagnetic induction. Alternatively, data packets may also be transmitted from the contactless payment terminal's transmitting antenna to the mobile device's receiving antenna when both antennas are located in each other's near electromagnetic field. In one embodiment, the near electromagnetic field for an antenna may be a distance measured from the antenna up to a single wavelength distance from the antenna. In one embodiment, the transmitting and receiving antennas of the mobile device may be the same antenna. In one embodiment, the transmitting and receiving antennas of the contactless payment terminal may be the same antenna. The term “antenna” as used here may include other hardware or devices that may be used to transmit or receive data packets.

In some embodiments of the invention, an encryption module at the mobile device encrypts the data packets prior to the mobile device transmitting the data packets to the contactless payment terminal. Encryption permits data packets to be securely transmitted to the contactless payment terminal such that the encrypted data packets may only be decrypted by the contactless payment terminal. In such an embodiment, the data packets may need to be decrypted by a decryption module at the contactless payment terminal when the data packets are received at the contactless payment terminal.

In one embodiment, the ISO/IEC 14443 standard may define the protocol associated with wirelessly transmitting data packets from the mobile device to the contactless payment terminal. However, in other embodiments, other standards may be utilized. Therefore, in one embodiment, the gift card data structure depicted in FIG. 9 may satisfy the ISO/IEC 14443 standard.

In one embodiment, the mobile device may transmit to or receive data packets from the contactless payment terminal in the radio frequency band of 13.56 MHz. In other embodiments, other frequency bands of the electromagnetic spectrum may be used to transmit or receive data packets. In one embodiment, the mobile device may transmit to or receive data packets from a contactless payment terminal situated within a distance of up to 25 cm. In other embodiments, the mobile device may transmit to or receive data packets from a contactless payment terminal situated at a distance greater than 25 cm.

In one embodiment, a power source at the mobile device may provide the energy required to initiate a transmission of data packets via radio frequency electromagnetic waves once the transmitting antenna of the mobile device identifies the presence of the receiving antenna at the contactless payment terminal. In another embodiment, the contactless payment terminal may produce an external electromagnetic field that provides the energy to allow the mobile device's transmitting antenna to initiate a transmission of data packets via radio frequency electromagnetic waves.

In one embodiment, a user may turn “off” the transmitting antenna of the mobile device so that even when the mobile device is “tapped” at or held close to the contactless payment terminal, data packets are not transmitted from the mobile device to the contactless payment terminal. In another embodiment, the transmitting antenna of the mobile device may always be “on” and the user may not be able to turn “off” the transmitting antenna of the mobile device.

The process then moves to block 108 where the contactless payment terminal receives a first data packet from the user. In one embodiment, the contactless payment terminal indicates that it has received the first data packet by producing an audible beep. In another embodiment, the contactless payment terminal indicates that it has received the first data packet by changing the color associated with one or more light emitting diodes (LED) that are situated on the contactless payment terminal or by switching the one or more LEDs from an “off” state to an “on” state. The method by which the contactless payment terminal may indicate that it has received the first data packet is not limited to these embodiments. In one embodiment, the contactless payment terminal may not indicate, at all, that it has received the first data packet.

The process then moves to block 112 where the contactless payment terminal identifies the first data packet. In one embodiment, the contactless payment terminal identifies the first data packet by identifying the protocol associated with the first data packet. For instance, the contactless payment terminal may identify that the first data packet is a gift card data packet by identifying the gift card protocol associated with the first data packet. As indicated above, in one embodiment where the received data packet is similar to that shown in FIG. 9, the contactless payment terminal may identify the received data packet as a gift card data packet by decoding block 658 which may carry the bytes that identify the type of data being transmitted from the mobile device, e.g., gift card data, credit card data, debit card data, or the like. Also as indicated above, in another embodiment, the contactless payment terminal may algorithmically identify the received data packet as a gift card data packet by directly decoding the data received in block 660 of the data structure.

The process then moves to block 116 where the contactless payment terminal determines whether the gift card data identified in block 112 constitutes a valid gift card. The rules that define whether the gift card data constitutes a valid gift card may be set by the entity from which the user makes a purchase. For instance, the algorithm that defines the gift card validation process may comprise determining whether the gift card has expired, whether the gift card may be used for this purchase, whether the gift card has a positive balance, or the like.

If the contactless payment terminal determines at block 116 that the gift card data is not valid, the contactless payment terminal may generate and present a message to the user. In an embodiment, the contactless payment terminal may also present the reason why the gift card is not valid. In an embodiment, the contactless payment terminal may also allow the user to attempt the transaction with another gift card.

If the contactless payment terminal determines at block 116 that the gift card data is valid, the contactless payment terminal may process the gift card data at block 124. In one embodiment, processing the gift card data may comprise the contactless payment terminal determining an absolute deductible amount or a percentage deductible amount associated with the gift card data. For instance, the gift card data may comprise discount data such that the contactless payment terminal may deduct either a percentage amount, e.g., 10%, off the first payment amount, or an absolute amount, e.g., $2, off the first payment amount. Subsequently, in response to determining an absolute deductible amount, the contactless payment terminal may subtract the absolute deductible amount from the first payment amount. Alternatively, in response to determining a percentage deductible amount, the contactless payment terminal may subtract from the first payment amount the percentage deductible amount of the first payment amount.

In one embodiment, processing the gift card data may comprise the contactless payment terminal transmitting the gift card data and data regarding the user's purchase to a separate processing system. In such an embodiment, the processing system may determine the deductible amount associated with the gift card data and subtract the deductible amount from the first payment amount to generate the second payment amount, and subsequently relay this second payment amount to the contactless payment terminal.

Then process then moves to block 128 where the contactless payment terminal generates a second payment amount. On most occasions, this second payment amount is less than the first payment amount.

The process then moves to block 132 where the contactless payment terminal determines whether the second payment amount is greater than zero.

If the contactless payment terminal determines at block 132 that the second payment amount is not greater than zero, the contactless payment terminal processes the gift card data at block 136. In one embodiment, processing the gift card data may comprise transmitting the gift card data to a processing system. In some embodiments, the processing system may also record a unique identifier associated with the gift card data. This is useful in some embodiments so that the user may not re-use exhausted value of the same gift card, as perceived by the contactless payment terminal, or the same coupon, as perceived by the user. In some embodiments, the gift card, as perceived by the contactless payment terminal, may still have some monetary value if the monetary value of the gift card is greater than the first payment amount. In such embodiments, the processing system may record the remaining value of the gift card and store the information either locally or remotely. In such embodiments, the remaining monetary value of the coupon, as perceived by the user, may be used by the user for achieving a discount in the future.

If the contactless payment terminal determines at block 132 that the second payment amount is greater than zero, the contactless payment terminal presents the second payment amount at block 140 to the user. For instance, if the user successfully transmitted a “$2 off” coupon to the contactless payment terminal, the contactless payment terminal may present a second payment amount of “$3.”

The process moves to block 176 where the mobile device presents a plurality of payment vehicles to the user. In one embodiment, a user may have previously entered information for each payment vehicle and may have directed the mobile device to store the information either locally on the mobile device or at a remote server. Therefore, the mobile device may either present these locally stored payment vehicles or may dynamically access the payment vehicles from a remote server and present them to the user. In one embodiment, the mobile device may also present an option for a user to enter information for a new payment vehicle.

The process moves to block 192 where the user selects a payment vehicle. For instance, in one embodiment, the user may select “American Express” as the payment vehicle. In another embodiment, the user may select multiple payment vehicles and the percentage amount of the second payment amount or an absolute amount to be paid from each payment vehicle. In one embodiment, a user may select a gift card as the payment vehicle.

The process then moves to block 180 where the mobile device receives the user's selection of one or more payment vehicles. In one embodiment, the mobile device may automatically select one or more payment vehicles without presenting the one or more payment vehicles to the user and without allowing the user to select a payment vehicle. The process of automatically selecting a payment vehicle by a mobile device may be based on a pre-determined algorithm that takes into account various parameters including the place of purchase, the type of purchase, the amount of the purchase, the type of payment vehicle selected, the payment vehicle's balance, whether the payment vehicle may be used at the place of purchase, whether the payment vehicle has been used previously at the place of purchase, whether using the payment vehicle would result in earning reward points, whether using the payment vehicle would result in achieving a discount on the purchase price, whether using the payment vehicle would result in a rebate, or the like. In some embodiments, the place of purchase, type of purchase, the purchase amount, etc., may have been determined previously when the mobile device automatically selects the one or more coupons that produce the maximum benefit to the user. In other embodiments, the place of purchase, type of purchase, the purchase amount, etc., may be determined when the mobile device interacts with the contactless payment terminal, as described below, when the mobile device is “tapped” at or held close to the contactless payment terminal. In another embodiment, the place of purchase, type of purchase, the purchase amount, etc., may be determined using the global positioning system in the mobile device or in a remote server in communication with the mobile device. In another embodiment, the user may enter input into the mobile device to indicate to the mobile device the type of purchase, place of purchase, purchase amount, etc. For instance, the user may input into the mobile device the entity from which the user made a purchase (e.g., fast food restaurant) along with the type of purchase (e.g., cheeseburger meal), etc., and subsequently, the mobile device may automatically select the one or more payment vehicles based on this input.

In some embodiments the contactless payment terminal may only be able to read and process payment vehicle data associated with a first type of protocol. In these embodiments, an emulation module at the mobile device may emulate payment vehicle data associated with a second type of protocol as payment vehicle data associated with the first type of protocol. In one embodiment, this emulation module may be different from the previously described emulation module that emulates coupon data as gift card data.

In the embodiments where the contactless payment terminal may only be able read and process payment vehicle data associated with a first type of protocol, the mobile device may have to determine the first type of protocol in order to transmit payment vehicle data that is readable and processable by the contactless payment terminal. In one embodiment, a user may enter input into the mobile device that indicates the first type of protocol, e.g., “American Express ExpressPay” protocol. In other embodiments, the mobile device may automatically determine that the entity's contactless payment terminal may only be able to read and process payment vehicle data associated with a first type of protocol by determining the place of purchase, or the like, using, for instance, the global positioning system of the mobile device as described in previous embodiments. In some embodiments, the place of purchase, or the like, may have been determined previously when the mobile device selects the one or more coupons. In other embodiments, the place of purchase, or the like, may be determined when the mobile device interacts with the contactless payment terminal when the mobile device is “tapped” at or held close to the contactless payment terminal.

In one embodiment, the mobile device subsequently instructs the user to “tap” (e.g., wave or hold) the mobile device in close proximity to the contactless payment terminal.

The process then moves to block 184 where the mobile device transmits the payment vehicle data as part of a second data packet to the contactless payment terminal. Block 184 comprises the second “tap” of the two “tap” process flow.

The mobile device must transmit data to the contactless payment terminal in a format that is readable and processable by the contactless payment terminal; otherwise, the user may not be able to make a contactless payment via a mobile device. The mobile device may transmit the second data packet via any of a number of near field communication techniques.

In one embodiment, the mobile device may transmit data packets via radio frequency electromagnetic waves emanating from the mobile device's transmitting antenna when the mobile device is “tapped” at or held or waved in close proximity to the contactless payment terminal. When the mobile device's transmitting antenna and the contactless payment terminal's receiving antenna are located in each other's electromagnetic field, they effectively form a transformer and data packets may be transmitted from the mobile device to the contactless payment terminal via electromagnetic induction. Alternatively, data packets may also be transmitted from the contactless payment terminal's transmitting antenna to the mobile device's receiving antenna when both antennas are located in each other's electromagnetic field. In one embodiment, the transmitting and receiving antennas of the mobile device may be the same antenna. In one embodiment, the transmitting and receiving antennas of the contactless payment terminal may be the same antenna.

In one embodiment, an encryption module at the mobile device may encrypt the data packets prior to the mobile device transmitting the data packets to the contactless payment terminal. Encryption permits data packets to be securely transmitted to the contactless payment terminal such that the encrypted data packets may only be decrypted by the contactless payment terminal. In such an embodiment, the data packets may need to be decrypted by a decryption module at the contactless payment terminal when the data packets are received at the contactless payment terminal.

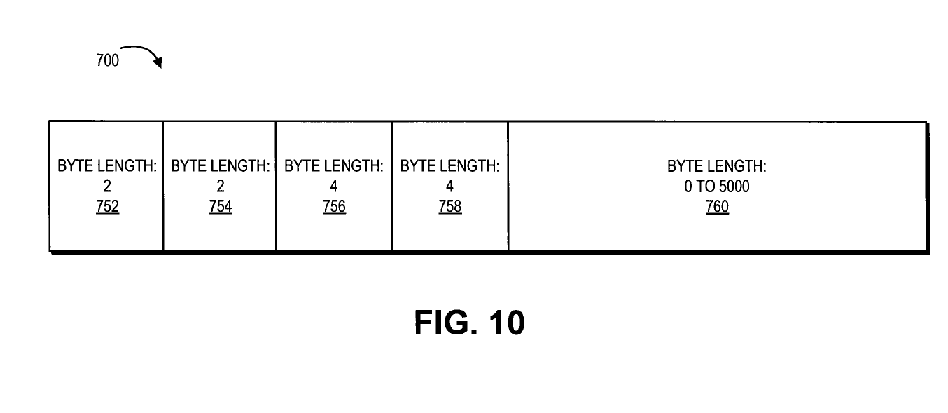

In one embodiment, the ISO/IEC 14443 standard may define the protocol associated with wirelessly transmitting data packets from the mobile device to the contactless payment terminal. However, in other embodiments, other standards may be utilized. Therefore, in one embodiment, the second data packet structure, i.e., the payment vehicle data structure depicted in FIG. 10 may satisfy the ISO/IEC 14443 standard.

In one embodiment, the mobile device may transmit to or receive data packets from the contactless payment terminal in the radio frequency band of 13.56 MHz. In other embodiments, other frequency bands of the electromagnetic spectrum may be used to transmit or receive data packets. In one embodiment, the mobile device may transmit to or receive data packets from a contactless payment terminal situated within a distance of up to 25 cm. In other embodiments, the mobile device may transmit to or receive data packets from a contactless payment terminal situated at a distance greater than 25 cm.

In one embodiment, a power source at the mobile device may provide the energy required to initiate a transmission of data packets via radio frequency electromagnetic waves once the transmitting antenna of the mobile device identifies the presence of the receiving antenna at the contactless payment terminal. In another embodiment, the contactless payment terminal may produce an external electromagnetic field that provides the energy to allow the mobile device's transmitting antenna to initiate a transmission of data via radio frequency electromagnetic waves.

In one embodiment, a user may turn “off” the transmitting antenna of the mobile device so that even when the mobile device is “tapped” at or held close to the contactless payment terminal, data packets are not transmitted from the mobile device to the contactless payment terminal. In another embodiment, the transmitting antenna of the mobile device may always be “on” and the user may not be able to turn “off” the transmitting antenna of the mobile device.

The process then moves to block 144 where the contactless payment terminal receives a second data packet from the user. In one embodiment, the contactless payment terminal may indicate that it has received the second data packet by producing an audible beep. In another embodiment, the contactless payment terminal may indicate that it has received the second data packet by changing the color associated with one or more light emitting diodes (LEDs) that are situated on the contactless payment terminal or by switching one or more LEDs from an “off” state to an “on” state. The method by which the contactless payment terminal may indicate that it has received the second data packet is not limited to these embodiments. In one embodiment, the contactless payment terminal may not indicate, at all, that it has received the second data packet.

The process then moves to block 148 where the contactless payment terminal identifies the second data packet. In one embodiment, the contactless payment terminal may identify the second data packet by identifying the protocol associated with the second data packet.

In one embodiment, the payment vehicle data packet protocol, i.e., the payment vehicle data packet structure that the contactless payment terminal recognizes as payment vehicle data, may be represented by the data structure 700 shown in FIG. 10. In this figure, block 752 may represent the bytes that carry information regarding the address of the source, i.e., the mobile device. Block 754 may represent the bytes that carry information regarding the address of the destination, i.e., the contactless payment terminal. Block 756 may represent the bytes that carry information which may be used to determine whether there were any transmission errors that corrupted the data transmitted from the mobile device. Block 758 may represent the bytes that identify the type of data being sent, e.g., “American Express” credit card data, “Visa” debit card data, or the like. Block 760 may represent the bytes that carry the payment vehicle data from the mobile device to the contactless payment terminal. When the contactless payment terminal receives the second data packet, it may identify and extract the payment vehicle data from block 760.

FIG. 10 merely serves as one instance of a payment vehicle data structure. For instance, FIG. 10 may represent an “ExpressPay” data structure or protocol such that when the second data packet is received by the contactless payment terminal, the contactless payment terminal identifies the second data packet as “American Express” payment vehicle data. In other embodiments, the “ExpressPay” data structure or protocol may be different from the payment vehicle data structure depicted in FIG. 10. In other embodiments, other payment vehicle data structures may be different from the payment vehicle data structure depicted in FIG. 10. For instance, the “PayPass” data structure or protocol associated with “MasterCard” payment vehicle data or the “payWave” data structure or protocol associated with “Visa” payment vehicle data may be different from the data structure presented in FIG. 10. For instance, in some embodiments, the payment vehicle data structure may not comprise of block 758 which carries the bytes that identify the type of payment vehicle data being sent from the mobile device. In such an embodiment, the contactless payment terminal may algorithmically identify the type of payment vehicle data that it received as payment vehicle data by directly decoding the data that is carried in block 760 of the data packet structure.

In embodiments where the selected payment vehicle is a gift card, the protocol associated with the second data packet transmitted in block 184 may be the same or similar to the protocol associated with the first data packet transmitted in block 174.

The process then moves to block 152 where the contactless payment terminal determines whether the payment vehicle data identified in block 148 constitutes a valid payment vehicle. The rules that define whether the payment vehicle data constitutes a valid payment vehicle may be set by the entity from which the user makes a purchase. For instance, the algorithm that defines the payment vehicle validation process may comprise determining whether the payment vehicle has expired, whether the payment vehicle is accepted by the entity, whether the payment vehicle may be used for this purchase, or the like.

If the contactless payment terminal determines at block 156 that the payment vehicle data is not valid, the contactless payment terminal may generate and present a message to the user. In an embodiment, the contactless payment terminal may also present the reason why the payment vehicle is not an accepted form of payment. In an embodiment, the contactless payment terminal may also allow the user to attempt the transaction with another payment vehicle.

If the contactless payment terminal determines at block 152 that the payment vehicle data is valid, the contactless payment terminal processes the payment vehicle data at block 160. In one embodiment, processing the payment vehicle data may comprise transmitting the payment vehicle data to a processing system from where the payment vehicle data may be routed to the entity's processing financial institution for authorization of payment vehicle data, capture of electronic funds from the source authorized by the payment vehicle, and deposit of electronic funds into a destination account specified by the entity. In some embodiments, the processing system may prompt the contactless payment terminal to request the user to authorize payment via the payment vehicle, e.g., requesting the user for a digital signature on the contactless payment terminal, on an electronic receipt, on a paper receipt, or the like. In some embodiments, the processing system may prompt the contactless payment terminal to request the user to authorize payment via the contactless payment terminal if the second payment amount is above a certain threshold amount.

### 1. Single “Tap” Contactless Payment Process Flow

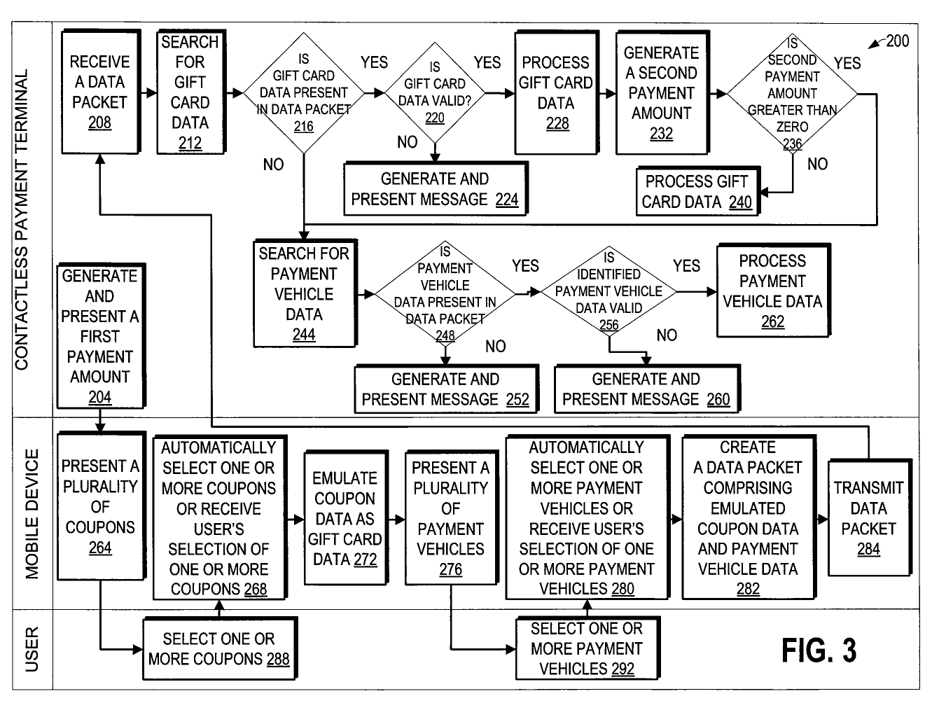

FIG. 3 provides a flow chart illustrating a single “tap” process 200 for making a payment using a coupon at a contactless payment terminal via a mobile device, in accordance with an embodiment of the invention. The entities illustrated in the figure include: (1) a contactless payment terminal; (2) a mobile device; and (3) a user making a payment at a contactless payment terminal via a mobile device. However, it should be noted that other entities could also be involved and some embodiments of the invention may not be limited to the entities illustrated in FIG. 3. Additionally, it should be understood that, in other embodiments of the invention, the entities need not be required to perform the actions illustrated in each respective swim lane.

The process flow 200 starts at block 204 where the contactless payment terminal generates and presents a first payment amount to the user. For instance, at a fast food restaurant, the contactless payment terminal may generate and present an amount of “$5” for a purchase.

The process moves to block 264 where the mobile device presents a plurality of coupons to the user. In one embodiment, the mobile device may dynamically access the plurality of coupons from a remote coupon server and present these coupons to the user. In another embodiment, the mobile device may access a plurality of coupons that are stored locally on the mobile device. In another embodiment, the mobile device may store the plurality of coupons that either have been previously download by the user or have been automatically downloaded by the mobile device.

The process moves to block 288 where the user selects a presented coupon on the mobile device. For instance, in one embodiment where the user makes a purchase at a fast food restaurant, the user may select a “$2 off” coupon for that particular fast food restaurant. In another embodiment, the user may select one or more coupons. Therefore, if the restaurant allows a user to stack multiple coupons, the user may, for instance, select a “$2 off” coupon along with a “$1 off” coupon.

The process then moves to block 268 where the mobile device receives the user's selection of one or more coupons. In one embodiment, the mobile device may automatically select one or more coupons without presenting the one or more coupons to the user and without allowing the user to select one or more coupons. The process of automatically selecting a coupon by a mobile device may be based on a pre-determined algorithm that takes into account various parameters including the place of purchase, the type of purchase, the amount of the purchase, whether a coupon has been used previously, or the like. For instance, in one instance, when the user makes a purchase at a fast food restaurant, the mobile device may identify the place of purchase and the type of purchase made by the user, and may automatically select one or more coupons that produces the maximum benefit, which, in most cases, produces the biggest discount to the user. In one instance, the mobile device may identify the type of purchase made by the user by communicating with the contactless payment terminal, as described below, when the mobile device is held close to or “taps” the contactless payment terminal. In another embodiment, the mobile device or a remote server in communication with the mobile device may be configured to identify the place of purchase using global positioning system capabilities of the mobile device. In another embodiment, the user may enter input into the mobile device to indicate to the mobile device the type of purchase, place of purchase, etc. For instance, the user may input into the mobile device the entity from which the user made a purchase (e.g., a fast food restaurant) along with the type of purchase (e.g., a cheeseburger meal), and subsequently, the mobile device may automatically select the one or more coupons that produces the maximum benefit to the user. As stated earlier, the coupons that produce the maximum benefit to the user are usually those that result in the largest discount.

The process then moves to block 272 where the mobile device emulates the coupon data for the selected coupon as gift card data. As explained earlier, the contactless payment terminal may not be able to read and process coupon data. Therefore, in such embodiments, the mobile device may need to transmit gift card data, rather than coupon data, because gift card data is readable and processable by a contactless payment terminal. In one embodiment, the gift card data protocol may be “MIFARE” protocol or a variant of “MIFARE” protocol. In other embodiments, the gift card data protocol may be some other protocol.

In order to transmit gift card data rather than coupon data, the mobile device may comprise an emulation module that encodes the coupon data based on gift card protocol into a data packet that can be read and processed by the contactless payment terminal.

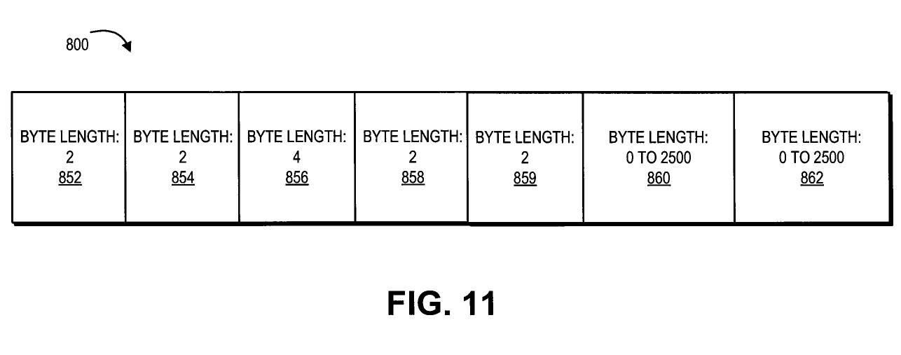

Data is transmitted from the mobile device to the contactless payment terminal via a plurality of data packets. Each data packet may have a pre-determined structure or protocol so that the contactless payment terminal may identify the type of data received based on the structure of the data packet. In one embodiment, the data packet protocol, i.e., the data packet structure may be represented by the data structure 800, is shown in FIG. 11. In this figure, block 852 may represent the bytes that carry information regarding the address of the source, i.e., the mobile device. Block 854 may represent the bytes that carry information regarding the address of the destination, i.e., the contactless payment terminal. Block 856 may represent the bytes that carry information which may be used to determine whether there were any transmission errors that corrupted the data transmitted from the mobile device. Block 858 may represent the bytes that identify the type of data carried in the bytes represented by block 860, e.g., gift card data, credit card data, debit card data, or the like. Block 859 may represent the bytes that identify the type of data carried in the bytes represented by block 862, e.g., gift card data, credit card data, debit card data, or the like. Block 860 may represent the bytes that carry one type of data from the mobile device to the contactless payment terminal. Block 862 may represent the bytes that carry another type of data from the mobile device to the contactless payment terminal.

In one embodiment, emulated coupon data may be carried in the bytes represented by block 860. In this embodiment, the emulation module at the mobile device may code the bytes carried in block 858 to indicate that gift card data is carried in block 860. In one embodiment, payment vehicle data may be carried in the bytes represented by block 862. In this embodiment, the emulation module at the mobile device may code the bytes carried in block 859 to indicate that payment vehicle data is carried in block 862. Therefore, in an embodiment, where the contactless payment terminal receives a data packet of the structure shown in FIG. 11, the contactless payment terminal may decode the bytes represented by block 858 to determine that the data carried in the bytes represented by block 860 is gift card data. Therefore, the contactless payment terminal may extract what it perceives as gift card data from block 860. Also, the contactless payment terminal may decode the bytes represented by block 859 to determine that the data carried in the bytes represented by block 862 is payment vehicle data. Therefore, the contactless payment terminal may extract payment vehicle data from block 862.

In some embodiments, existing contactless payment terminals may need to have their decoding algorithms altered in order to recognize the structure of data packets transmitted in the single “tap” process flow. In some embodiments, there may also be a necessity to implement other hardware or software modifications at the contactless payment terminal in order for the contactless payment terminal to recognize the structure of data packets transmitted in the single “tap” process flow. In some embodiments, only the software at the contactless payment terminal may need to be modified to execute the single “tap” process flow in the order of the process steps depicted in FIG. 2. In other embodiments, existing contactless payment terminals may be able to read and process the data packets transmitted in the single “tap” process flow without any hardware or software modifications at the contactless payment terminal.

FIG. 11 merely serves as one instance of a data packet structure transmitted in a single “tap” process flow. In other embodiments, the gift card data structure may be different from that depicted in FIG. 11. For instance, in another embodiment, the data packet structure may not comprise of blocks 858 and 859, which represent the bytes that identify the type of data being carried in blocks 860 and 862, respectively. In such an embodiment, the contactless payment terminal may algorithmically identify the type of data in blocks 860 and 862 by directly decoding the data that is carried in blocks 860 and 862 of the data packet structure.

In one embodiment, the emulation module that encodes the emulated coupon data as gift card data at the mobile device may be implemented in software only. In the software-only emulation module, a software routine may be used to encode the emulated coupon data into a block, e.g., block 860, of the data packet structure shown in FIG. 11. In another embodiment, the emulation module at the mobile device may be implemented using both hardware and software components.

In one embodiment, the emulation module may dynamically emulate the coupon data as gift card data in real-time after the user selects the coupon. In another embodiment, the emulation module may emulate the coupon data for a plurality of coupons stored locally or remotely, and may store the emulated coupon data either locally or remotely.

Referring again to FIG. 3, the process moves to block 276 where the mobile device presents a plurality of payment vehicles to the user. In one embodiment, a user may have previously entered information for each payment vehicle and may have directed the mobile device to store the information either locally on the mobile device or at a remote server. Therefore, the mobile device may either present these locally stored payment vehicles or may dynamically access the payment vehicles from a remote server and present them to the user. In one embodiment, the mobile device may also present an option for a user to enter information for a new payment vehicle.

The process moves to block 292 where the user selects a payment vehicle. For instance, in one embodiment, the user may select “American Express” as the payment vehicle. In another embodiment, the user may select multiple payment vehicles such as “American Express,” “MasterCard,” cash, etc. and the percentage or absolute amounts to be paid from each payment vehicle. In one embodiment, a user may select a gift card as the payment vehicle.

The process then moves to block 280 where the mobile device receives the user's selection of one or more payment vehicles. In one embodiment, the mobile device may automatically select one or more payment vehicles without presenting the one or more payment vehicles to the user and without allowing the user to select a payment vehicle. The process of automatically selecting a payment vehicle by a mobile device may be based on a pre-determined algorithm that takes into account various parameters including the place of purchase, the type of purchase, the amount of the purchase, the type of payment vehicle selected, the payment vehicle's balance, whether the payment vehicle has been used previously at the place of purchase, whether using the payment vehicle would result in earning reward points, whether using the payment vehicle would result in achieving a discount on the purchase price, whether using the payment vehicle would result in a rebate, or the like. In some embodiments, the place of purchase, type of purchase, the purchase amount, etc., may have been determined previously when the mobile device automatically selects the one or more coupons that produce the maximum benefit to the user. In other embodiments, the place of purchase, type of purchase, the purchase amount, etc., may be determined when the mobile device interacts with the contactless payment terminal, as described below, when the mobile device is “tapped” at or held close to the contactless payment terminal. In another embodiment, the place of purchase, type of purchase, the purchase amount, etc., may be determined using the global positioning system in the mobile device or in a remote server in communication with the mobile device. In another embodiment, the user may enter input into the mobile device to indicate to the mobile device the type of purchase, place of purchase, purchase amount, etc. For instance, the user may input into the mobile device the entity from which the user made a purchase (e.g., fast food restaurant) along with the type of purchase (e.g., cheeseburger meal), etc., and subsequently, the mobile device may automatically select the one or more payment vehicles based on this input.

In some embodiments, the contactless payment terminal may only be able to read and process payment vehicle data associated with a first type of protocol. In these embodiments, an emulation module at the mobile device may emulate payment vehicle data associated with a second type of protocol as payment vehicle data associated with the first type of protocol. In one embodiment, this emulation module may be different from the previously described emulation module that emulates coupon data a gift card data.

In the embodiments where the contactless payment terminal may only be able read and process payment vehicle data associated with a first type of protocol, the mobile device may have to determine the first type of protocol in order to transmit payment vehicle data that is readable and processable by the contactless payment terminal. In one embodiment, a user may enter input into the mobile device that indicates the first type of protocol, e.g., “American Express ExpressPay” protocol. In other embodiments, the mobile device may automatically determine that the entity's contactless payment terminal may only be able to read and process payment vehicle data associated with a first type of protocol by determining the place of purchase, or the like, using, for example, the global positioning system in the mobile device as described in previous embodiments. In some embodiments, the place of purchase, or the like, may have been determined previously when the mobile device selects the one or more coupons. In other embodiments, the place of purchase, or the like, may be determined when the mobile device interacts with the contactless payment terminal when the mobile device is “tapped” at or held close to the contactless payment terminal.

The process then moves to block 282 where the mobile device creates a data packet that comprises the above-described emulated coupon data and the above-described payment vehicle data. This data packet may have the structure of the data packet shown in FIG. 11, which has been described earlier.

In one embodiment, the mobile device subsequently instructs the user to “tap” (e.g., wave or hold) the mobile device in close proximity to the contactless payment terminal.

The process then moves to block 284 where the mobile device transmits the data packet to the contactless payment terminal. The mobile device may transmit the data packet via any of a number of near field communication techniques. Block 284 comprises the single “tap” of the single “tap” process flow.

In the single “tap” process flow, the effect of selecting a coupon and a payment vehicle on the mobile device may produce a result where the contactless payment terminal perceives that it has received a data packet that may comprise gift card data and payment vehicle data. Therefore, while a user perceives that a coupon and a payment vehicle have been transmitted from the mobile device to the contactless payment terminal, the contactless payment terminal may receive a gift card and a payment vehicle, both of which are readable and processable by the contactless payment terminal.

In one embodiment, the mobile device may transmit data packets via radio frequency electromagnetic waves emanating from the mobile device's transmitting antenna when the mobile device is “tapped” (e.g., held or waved) in close proximity to the contactless payment terminal. When the mobile device's transmitting antenna and the contactless payment terminal's receiving antenna are located in each other's electromagnetic field, they may effectively form a transformer and data packets are transmitted from the mobile device to the contactless payment terminal via electromagnetic induction. Alternatively, data packets may also be transmitted from the contactless payment terminal's transmitting antenna to the mobile device's receiving antenna when both antennas are located in each other's near electromagnetic field. In one embodiment, the near electromagnetic field for an antenna may be a distance measured from the antenna up to a single wavelength distance from the antenna. In one embodiment, the transmitting and receiving antennas of the mobile device may be the same antenna. In one embodiment, the transmitting and receiving antennas of the contactless payment terminal may be the same antenna. The term “antenna” as used here may include other hardware or devices that may be used to transmit or receive data packets.

In one embodiment, an encryption module at the mobile device may encrypt the data packet prior to the mobile device transmitting the data packet to the contactless payment terminal. Encryption permits data to be securely transmitted to the contactless payment terminal such that the encrypted data packet may only be decrypted by the contactless payment terminal. In such an embodiment, the data packet may need to be decrypted by a decryption module at the contactless payment terminal when the data packet is received at the contactless payment terminal.

In one embodiment, the ISO/IEC 14443 standard may define the protocol associated with wirelessly transmitting the data packet from the mobile device to the contactless payment terminal. However, in other embodiments, other standards may be utilized. Therefore, in one embodiment, the data packet structure depicted in FIG. 11 may satisfy the ISO/IEC 14443 standard.

In one embodiment, the mobile device may transmit to or receive data packets from the contactless payment terminal in the radio frequency band of 13.56 MHz. In other embodiments, other frequency bands of the electromagnetic spectrum may be used to transmit or receive data packets. In one embodiment, the mobile device may transmit to or receive data packets from a contactless payment terminal situated within a distance of up to 25 cm. In other embodiments, the mobile device may transmit to or receive data packets from a contactless payment terminal situated at a distance greater than 25 cm.

In one embodiment, a power source at the mobile device may provide the energy required to initiate a transmission of data packets via radio frequency electromagnetic waves once the transmitting antenna of the mobile device identifies the presence of the receiving antenna at the contactless payment terminal. In another embodiment, the contactless payment terminal may produce an external electromagnetic field that provides the energy to allow the mobile device's transmitting antenna to initiate a transmission of data packets via radio frequency electromagnetic waves.

In one embodiment, a user may turn “off” the transmitting antenna of the mobile device so that even when the mobile device is “tapped” at or held close to the contactless payment terminal, data packets are not transmitted from the mobile device to the contactless payment terminal. In another embodiment, the transmitting antenna of the mobile device may always be “on” and the user may not be able to turn “off” the transmitting antenna of the mobile device.

The process then moves to block 208 where the contactless payment terminal receives a data packet from the user. In one embodiment, the contactless payment terminal may indicate that it has received the data packet by producing an audible beep. In another embodiment, the contactless payment terminal may indicate that it has received the data packet by changing the color associated with one or more light emitting diodes (LEDs) that are situated on the contactless payment terminal or by switching the one or more LEDs from an “off” state to an “on” state. The method by which the contactless payment terminal may indicate that it has received the data packet is not limited to these embodiments. In one embodiment, the contactless payment terminal may not indicate, at all, that it has received the data packet.

The process then moves to block 212 where the contactless payment terminal may search the data packet for gift card data. In one embodiment where the data packet is similar to the data packet shown in FIG. 11, the contactless payment terminal may identify (at block 216 of FIG. 3) the gift card data represented by block 860 by decoding the bytes carried in block 858. Alternatively, as indicated above, in another embodiment, the contactless payment terminal may algorithmically identify the gift card data of block 860 by directly decoding the data received in block 860 of the data structure.

If the contactless payment terminal identifies gift card data at block 216, then the process then moves to block 220 where the contactless payment terminal may determine whether the gift card data identified in block 216 constitutes a valid gift card. The rules that define whether the gift card data constitutes a valid gift card may be set by the entity from which the user makes a purchase. For instance, the algorithm that defines the gift card validation process may comprise determining whether the gift card has expired, whether the gift card may be used for this purchase, whether the gift card has a positive balance, or the like.

If the contactless payment terminal determines at block 220 that the gift card data is not valid, the contactless payment terminal generates and presents a message to the user. In an embodiment, the contactless payment terminal may also present the reason why the gift card is not valid. In an embodiment, the contactless payment terminal may also allow the user to attempt the transaction with another gift card.

If the contactless payment terminal determines at block 220 that the gift card data is valid, the contactless payment terminal may process the gift card data at block 228. In one embodiment, processing the gift card data may comprise the contactless payment terminal determining an absolute deductible amount or a percentage deductible amount associated with the gift card data. For instance, the gift card data may comprise discount data such that the contactless payment terminal may deduct either a percentage amount, e.g., 10%, off the first payment amount, or an absolute amount, e.g., $2, off the first payment amount. Subsequently, in response to determining an absolute deductible amount, the contactless payment terminal may subtract the absolute deductible amount from the first payment amount. Alternatively, in response to determining a percentage deductible amount, the contactless payment terminal may subtract from the first payment amount the percentage deductible amount of the first payment amount.

In one embodiment, processing the gift card data may comprise the contactless payment terminal transmitting the gift card data and data regarding the user's purchase to a separate processing system. In such an embodiment, the processing system may determine the deductible amount associated with the gift card data and subtract the deductible amount from the first payment amount to generate the second payment amount, and subsequently relay this second payment amount to the contactless payment terminal.

Then process then moves to block 232 where the contactless payment terminal generates a second payment amount. On most occasions, this second payment amount is less than the first payment amount.

The process then moves to block 236 where the contactless payment terminal determines whether the second payment amount is greater than zero.

If the contactless payment terminal determines at block 236 that the second payment amount is not greater than zero, the contactless payment terminal processes the gift card data at block 240. In one embodiment, processing the gift card data may comprise transmitting the gift card data to a processing system. In some embodiments, the processing system may also record a unique identifier associated with the gift card data. This is useful in some embodiments so that the user may not re-use the exhausted value of the same gift card, as perceived by the contactless payment terminal, or the same coupon, as perceived by the user. In some embodiments, the gift card, as perceived by the processing system, may still have some monetary value if the monetary value of the gift card is greater than the first payment amount. In such embodiments, the processing system may record the remaining value of the gift card and store the information either locally or remotely. In such embodiments, the remaining monetary value of the coupon, as perceived by the user, may be used by the user in the future.

If the contactless payment terminal determines at block 236 that the second payment amount is greater than zero, the contactless payment terminal may generate, but not present, the second payment amount to the user. For instance, if the user successfully transmitted a “$2 off” coupon to the contactless payment terminal via the data packet, the contactless payment terminal may generate a second payment amount of “$3.”

The process then moves to block 244 where the contactless payment terminal searches the data packet for payment vehicle data. Also, as shown in FIG. 11, the process flow may move directly to this block when the contactless payment terminal does not identify any gift card data in the data packet at block 216 of the process flow. In one embodiment where the data packet is similar to the data packet shown in FIG. 11, the contactless payment terminal may identify (at block 248 of FIG. 3) the payment vehicle data represented by block 862 by decoding the bytes carried in block 859. For instance, the bytes carried in block 859 may indicate that payment vehicle data carried in block 862 is “American Express” credit card data, “Visa” debit card data, or the like. Also as indicated above, in another embodiment, the contactless payment terminal may algorithmically identify the payment vehicle data of block 862 by directly decoding the data received in block 862 of the data structure. For instance, the contactless payment terminal may identify the data received in block 862 is “American Express” payment vehicle data by identifying the protocol associated with the data as “ExpressPay” protocol. Alternatively, the contactless payment terminal may identify that the data received in block 862 is “MasterCard” or “Visa” payment vehicle data by identifying the protocol associated with the data as “PayPass” or “payWave” protocol, respectively. In an embodiment where the payment vehicle is a gift card, the contactless payment terminal may identify that the data received in block 862 is a gift card by identifying the protocol associated with the data as gift card protocol such as “MIFARE” protocol, or the like.

If the contactless payment terminal identifies does not identify payment vehicle data at block 248, then the process then moves to block 252 where the contactless payment terminal may generate and present a message to the user. This message may indicate to the user that the contactless payment terminal did not identify any payment vehicle data. The message may also request the user to attempt the transaction again using the same or another payment vehicle.

If the contactless payment terminal identifies payment vehicle data at block 248, then the process then moves to block 256 where the contactless payment terminal may determine whether the payment vehicle data identified in block 248 constitutes a valid payment vehicle. The rules that define whether the gift card data constitutes a valid payment vehicle may be set by the entity from which the user makes a purchase. For instance, the algorithm that defines the payment vehicle validation process may comprise determining whether the payment vehicle has expired, whether the payment vehicle is accepted by the entity, whether the payment vehicle may be used for this purchase, or the like.

If the contactless payment terminal determines at block 256 that the payment vehicle data is not valid, the contactless payment terminal may generate and present a message to the user. In an embodiment, the contactless payment terminal may also present the reason why the payment vehicle is not an accepted form of payment. In an embodiment, the contactless payment terminal may also allow the user to attempt the transaction with another payment vehicle.

If the contactless payment terminal determines at block 256 that the payment vehicle data is valid, the contactless payment terminal may process the payment vehicle data at block 262. In one embodiment, processing the payment vehicle data may comprise transmitting the payment vehicle data to a processing system from where the payment vehicle data may be routed to the entity's processing financial institution for authorization of payment vehicle data, capture of electronic funds from the source authorized by the payment vehicle, and deposit of electronic funds into a destination account specified by the entity. In some embodiments, the processing system may prompt the contactless payment terminal to request the user to authorize payment via the payment vehicle, e.g., requesting the user for a digital signature on the contactless payment terminal, on an electronic receipt, on a paper receipt, or the like. In some embodiments, the processing system may prompt the contactless payment terminal to request the user to authorize payment via the contactless payment terminal if the second payment amount is above a certain threshold amount.

### Alternative Embodiment

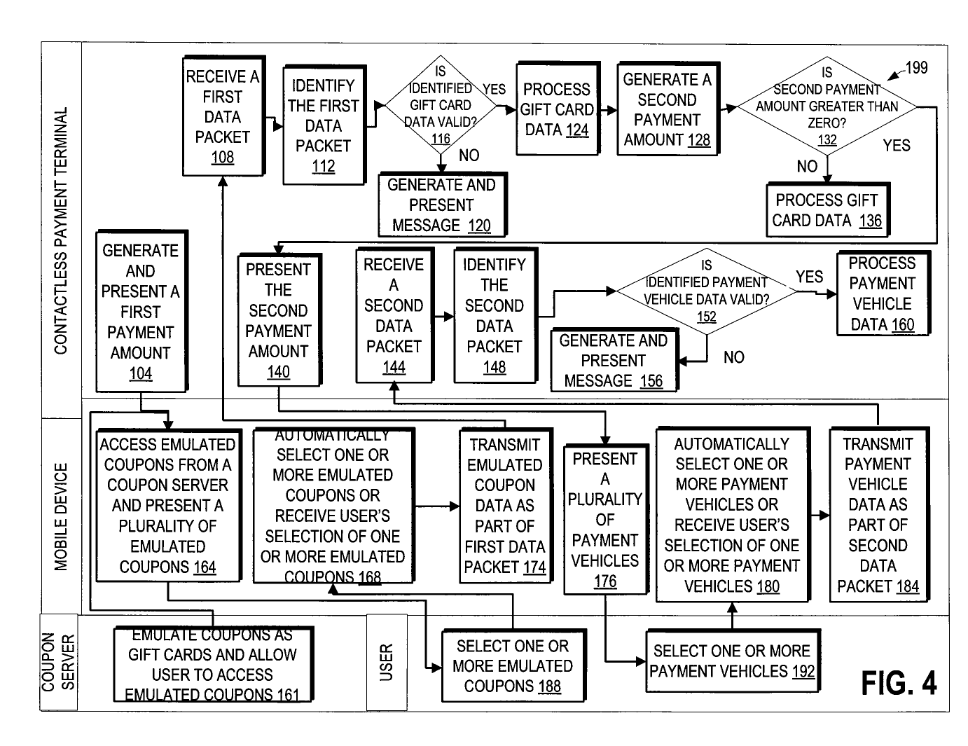

FIG. 4 provides a flow chart illustrating a two “tap” process 199 for making a payment using an electronic coupon at a contactless payment terminal via a mobile device, in accordance with an embodiment of the invention. FIG. 4 illustrates the flow chart in terms of “swim lanes” associated with entities which may perform the operations in each respective swim lane. The entities illustrated in the exemplary Figure are (1) a contactless payment terminal, (2) a mobile device, and (3) a user making a payment at a contactless payment terminal via a mobile device, and (4) a coupon server. However, it should be noted that other entities could also be involved and some embodiments of the invention may not be limited to the entities illustrated in FIG. 4. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process flow 199 starts at block 104 of FIG. 4 where the contactless payment terminal may generate and present a first payment amount to the user. For instance, at a fast food restaurant, the contactless payment terminal may generate and present an amount of “$5” for a purchase.

In this embodiment of the invention, a coupon server may emulate coupons as gift cards and store these emulated coupons. The coupon server may comprise an emulation module that emulates coupons as gift cards at block 161 of FIG. 4 according to embodiments of the emulation module presented earlier. The coupon server may allow a user to access these emulated coupons via a mobile device.

The process moves to block 164 of FIG. 4 where the mobile device may present a plurality of emulated coupons to the user. In one embodiment, the mobile device may dynamically access the plurality of emulated coupons from a remote coupon server and present these emulated coupons to the user. In another embodiment, the mobile device may access a plurality of emulated coupons, which have been downloaded earlier from the coupon server and are stored locally on the mobile device, or have been automatically downloaded by the mobile device from the coupon server.

The process moves to block 188 of FIG. 4 where the user may select an emulated coupon presented on the mobile device. For instance, in one embodiment where the user makes a purchase at a fast food restaurant, the user may select a “$2 off” emulated coupon for that particular fast food restaurant. In another embodiment, the user may select one or more emulated coupons. Therefore, if the restaurant allows a user to stack multiple emulated coupons, the user may, for instance, select a “$2 off” emulated coupon along with a “$1 off” emulated coupon. From a user's perspective, there may be no difference in how an emulated coupon is presented on a mobile device when compared to how a coupon is presented on the mobile device.

The process then moves to block 168 where the mobile device may receive the user's selection of one or more emulated coupons. In one embodiment, the mobile device may automatically select one or more emulated coupons without presenting the one or more emulated coupons to the user and without allowing the user to select one or more emulated coupons. The process of automatically selecting one or more emulated coupons may be similar to the process of automatically selecting one or more coupons as described in an earlier embodiment.

Since the mobile device does not emulate coupon data, the process flow moves to block 174 of FIG. 4, which has been described in earlier embodiments with respect to FIG. 2. The rest of the process flow mirrors the process flow described earlier with respect to FIG. 2.

### Contactless Payment System and Environment

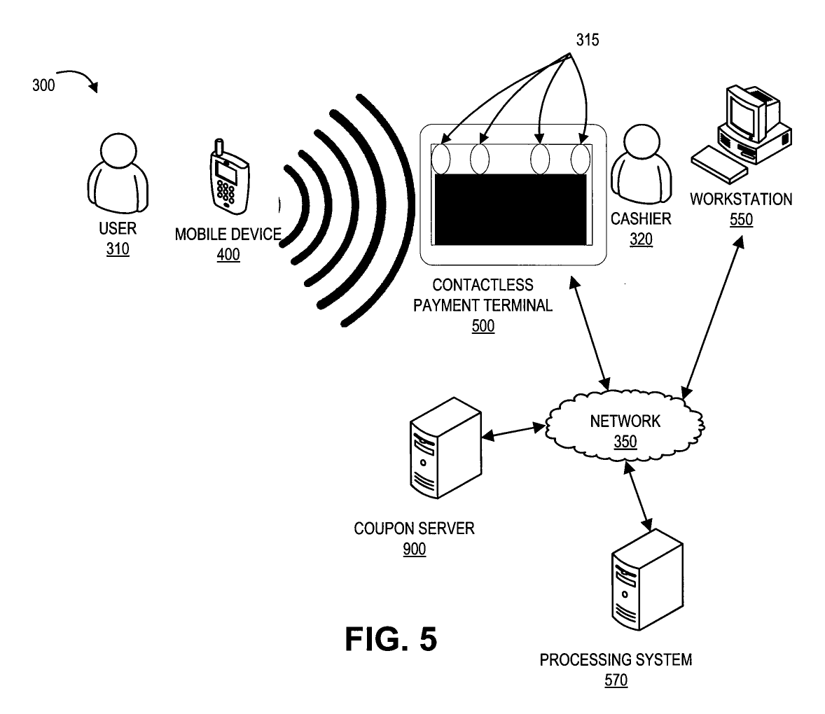

FIG. 5 provides a block diagram illustrating a contactless payment environment 300 configured for making a contactless payment via a mobile device, in accordance with an embodiment of the invention. As illustrated in FIG. 5, the contactless payment environment includes a mobile device 400 operable by a user 310 who may be a customer who wants to make a contactless payment via a mobile device. The contactless payment environment also includes a contactless payment terminal 500 that may be automated or may be operable by a cashier 320. The contactless payment terminal may permit a user to make a payment without any contact between the contactless payment terminal and the payment device, i.e., the mobile device. The contactless payment environment also includes a workstation 550 and a processing system 600 that are in electronic communication with the contactless payment terminal via a network 350, which may be the Internet, an intranet or the like. The contactless payment environment 300 may also include a coupon server 900 that is in communication with the mobile device 400 via a network 350. The LEDs 315 situated on the contactless payment terminal that perform the functions described above are also displayed in FIG. 5.

The network 350 may include a local area network (LAN), a wide area network (WAN), and/or a global area network (GAN). The network 350 may provide for wireline, wireless, or a combination of wireline and wireless communication between devices in the network. In one embodiment, the network 350 includes the Internet. In one embodiment, the network 350 may include a wireless telephone network.

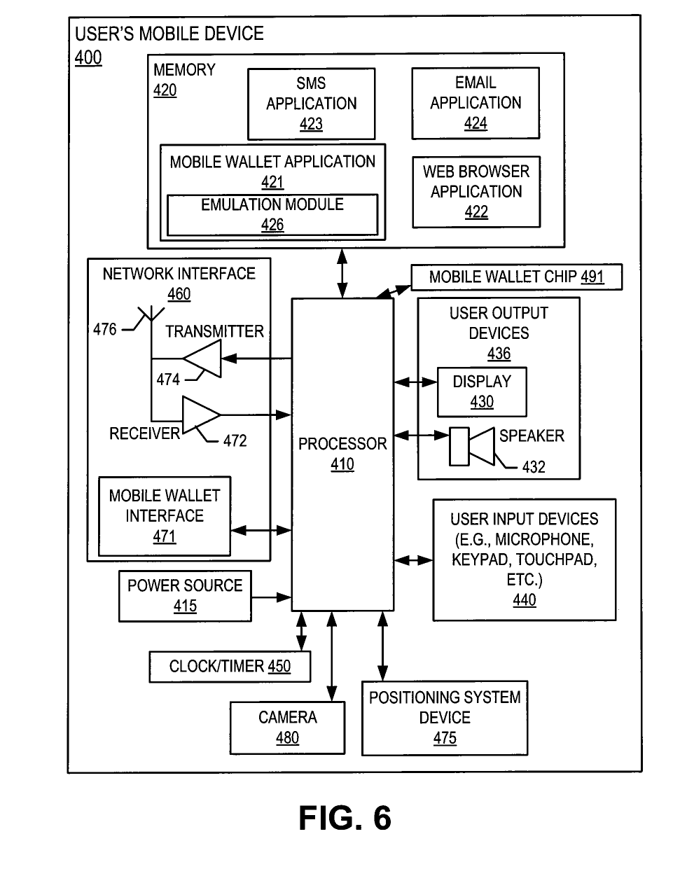

The mobile device 400, the contactless payment terminal 500, and the coupon server 900 are described in further detail below with respect to FIGS. 6, 7, and 8, respectively.

FIG. 6 displays an embodiment of a mobile device that is configured to make a payment by interacting with the contactless payment terminal 500. As used herein, a “mobile device” 400 may be any mobile communication device, such as a cellular telecommunications device (i.e., a cell phone or mobile phone), personal digital assistant (PDA), a mobile Internet accessing device, or other mobile device.

In one embodiment of the invention, the mobile device 400 is a mobile telephone. However, it should be understood, however, that a mobile telephone is merely illustrative of one type of mobile device 400 that may benefit from, employ, or otherwise be involved with embodiments of the present invention and, therefore, should not be taken to limit the scope of embodiments of the present invention. Other types of mobile devices 400 may include portable digital assistants (PDAs), pagers, mobile televisions, gaming devices, laptop computers, cameras, video recorders, audio/video player, radio, GPS devices, any combination of the aforementioned, or the like.

The mobile device 400 generally includes a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the mobile device 400. For example, the processor 410 may include a digital signal processor device, a microprocessor device, and various analog to digital converters, digital to analog converters, and/or other support circuits. Control and signal processing functions of the mobile device 400 may be allocated between these devices according to their respective capabilities. The processor 410 thus may also include the functionality to encode and interleave messages and data prior to modulation and transmission. The processor 410 may additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device 400 to transmit and receive web content, such as, for example, location-based content and/or other web page content, according to a Wireless Application Protocol (WAP), Hypertext Transfer Protocol (HTTP), and/or the like. The processor 410 may also be capable of operating a client application, such as a mobile wallet application that is represented by block 421.

As shown in FIG. 6, in one embodiment of the invention, the mobile wallet application 421 may be downloaded from an application server and stored in the mobile device's memory 420. In another embodiment, the mobile wallet application 421 may be pre-installed and stored in a memory in the mobile wallet chip 491. In such an embodiment, the user may not need to download the mobile wallet application 421 from an application server. In some embodiments, the mobile wallet application 421 may have a graphical user interface(GUI) that allows the user to perform various processes as described below. The GUI may also allow the user to set certain payment preferences or mobile wallet preferences.

The mobile wallet application 421 may be capable of performing each of the process blocks that were previously described as being performed by the mobile device 400 in FIGS. 1, 2, 3, and 4. The mobile wallet application 421 may also be capable of accessing from a remote server 900 accessible via a network, or from the mobile wallet chip 491, and presenting one or more coupons. The mobile wallet application 421 may be capable of automatically selecting one or more coupons or receiving a user's selection of one more coupons.

In some embodiments, the mobile wallet application 421 may also comprise an emulation module 426. In other embodiments, the emulation module 426 may be a separate module that works in conjunction with the mobile wallet application 421. The emulation module 426 may be capable of emulating coupon data as gift card data. The mobile wallet application 421 may also be capable of working in conjunction with the mobile device's hardware to transmit the emulated coupon data to the contactless payment terminal.

The mobile wallet application 421 may be capable of allowing a user to input information for new payment vehicles, or downloading payment vehicle information, via a network, from a user's account associated with a payment vehicle. Furthermore, the mobile wallet application 421 may be capable of accessing via a network, or from a mobile wallet chip 491, and presenting one or more payment vehicles, such as credit cards, debit cards, gift cards, or the like. The mobile wallet application 421 may be capable of automatically selecting one or more payment vehicles or receiving a user's selection of one more payment vehicles. The emulation module 426 of the mobile wallet application 421 may also be capable of emulating payment vehicle data associated with a first type of protocol as payment vehicle data associated with a second type of protocol. In one embodiment, the emulation module that is capable of emulating payment vehicle data associated with a first type of protocol as payment vehicle data associated with a second type of protocol may be different from the emulation module that is capable of emulating coupon data as gift card data. The mobile wallet application 421 may also be capable of working in conjunction with the mobile device's hardware to transmit the payment vehicle data to the contactless payment terminal.

As indicated above, in one embodiment, the mobile device 400 comprises a mobile wallet chip 491. This mobile wallet chip 491 may either be integrated into the mobile device, or it may be insertable and removable from the mobile device 400 by a user. A memory in the mobile wallet chip 491 may store payment vehicle data for a plurality of payment vehicles. A memory in the mobile wallet chip 491 may also store coupon data for a plurality of coupons, or coupon data emulated as gift card data for a plurality of coupons. In some embodiments, the mobile wallet chip 491 may also comprise the emulation module 426 described above. The mobile wallet application 421 may interact with the mobile wallet chip 491 and the mobile wallet interface 471 to perform the various processes described above.

The processor 410 may be configured to use the network interface 460 to communicate with one or more other devices on the network 350. In this regard, the network interface 460 may include an antenna 476 operatively coupled to a transmitter 474 and a receiver 472 (together a “transceiver”). The processor 410 may be configured to provide signals to and receive signals from the transmitter 474 and receiver 472, respectively. These signals may include radio frequency signals emanating from the mobile device's transmitter 474 when the mobile device is “tapped” at or held or waved in close proximity to the contactless payment terminal. These signals may also include radio frequency signals received at the mobile device's receiver 472 when the mobile device is “tapped” at or held or waved in close proximity to the contactless payment terminal. In one embodiment, these radio frequency signals may be transmitted and received in the radio frequency band of 13.56 MHz. In one embodiment, the ISO/IEC 14443 standard may define the protocol associated with the data carried by these radio frequency signals. In one embodiment, the transmitter 474 and receiver 472 at the mobile device may transmit and receive radio frequency signals, respectively, from a contactless payment terminal within a distance of up to 25 cm.

As indicated earlier, the processor 410 may be configured to provide signals to and receive signals from the transmitter 474 and receiver 472, respectively. The signals may also include signaling information in accordance with the air interface standard of the applicable cellular system of the wireless telephone network that may be part of the network 350. In this regard, the mobile device 400 may be configured to operate with one or more air interface standards, communication protocols, modulation types, and access types. By way of illustration, the mobile device 400 may be configured to operate in accordance with any of a number of first, second, third, and/or fourth-generation communication protocols and/or the like. For example, the mobile device 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 400 may also be configured to operate in accordance with non-cellular communication mechanisms, such as via a wireless local area network (WLAN) or other communication/data networks.

The network interface 460 may also include a mobile wallet interface 471 in order to allow a user to execute some or all of the above-described processes with respect to the mobile wallet application 421 and, in some embodiments, the emulation module 426. The mobile wallet interface 471 may have access to the hardware, e.g., the transceiver, and software previously described with respect to the network interface 460.

In some embodiments, the mobile wallet chip 491 may comprise the above-described mobile wallet interface 471. Therefore, in some embodiments, the hardware, e.g., the transceiver, for transmitting data packets via near-field communication (NFC) technology may be integrated into the mobile wallet chip 491. The software for transmitting data packets via NFC technology may be provided by the mobile wallet application 421 or some other application that works in conjunction with the mobile wallet interface 471.

As described above, the mobile device 400 may have a user interface that includes user output devices 436 and/or user input devices 440. The user output devices 436 may include a display 430 (e.g., a liquid crystal display (LCD) or the like) and a speaker 432 or other audio device, which are operatively coupled to the processor 410. The user input devices 440, which may allow the mobile device 400 to receive data from a user such as the user 110, may include any of a number of devices allowing the mobile device 400 to receive data from a user, such as a keypad, keyboard, touch-screen, touchpad, microphone, mouse, joystick, other pointer device, button, soft key, and/or other input device(s).

The mobile device 400 may further include a power source 415, such as a battery, for powering various circuits, e.g., the transceiver circuit, and other devices that are used to operate the mobile device 400. Embodiments of the mobile device 400 may also include a clock or other timer 450 configured to determine and, in some cases, communicate actual or relative time to the processor 410 or one or more other devices.

The mobile device 400 may additionally include a global positioning system 475 that allows the mobile device 400 to determine the geographical location of the mobile device 400 by interacting with a satellite.

The mobile device 400 may also include a memory 420 operatively coupled to the processor 410. As used herein, memory may include any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory may additionally or alternatively include an electrically erasable programmable read-only memory (EEPROM), flash memory or the like.

The memory 420 may store any of a number of applications which comprise computer-executable instructions/code executed by the processor 410 to implement the functions of the mobile device 400 described herein. For example, the memory 420 may include such applications as a web browser application 422 and a mobile wallet application 421. The mobile wallet application 421 may be capable of performing one or more of the processes described above. These applications may also typically provide a graphical user interface (GUI) on the display 430. For instance, the GUI for the mobile wallet application 421 may allow the user 110 to enter input to select a coupon or a payment vehicle.

The memory 420 may also store any of a number of pieces of information, and data, used by the mobile device 400 and the applications and devices that make up the mobile device 400 or are in communication with the mobile device 400 to implement the functions of the mobile device 400 and/or the other systems described herein. For example, the memory 420 may include such data as user authentication information to gain access to the mobile wallet application 421, user authentication information for each payment vehicle that is accessible via the mobile wallet application 421, user authentication information to access the mobile wallet chip 491, etc. In other embodiments, this authentication information may be stored in a memory of the mobile wallet chip 491.

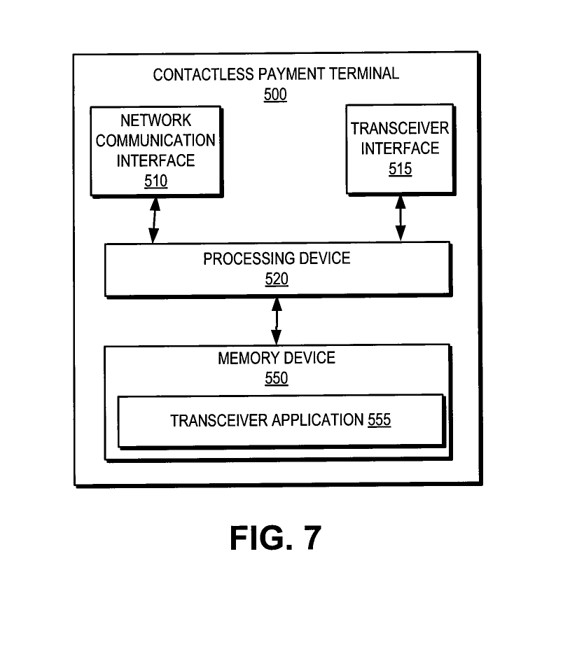

FIG. 7 displays an embodiment of a contactless payment terminal 500. The contactless payment terminal 500 includes various features, such as a network communication interface 510, a processing device 520, a transceiver interface 515, and a memory device 550 that may include a transceiver application 555.

As used with respect to the contactless payment terminal 500, a “communication interface” may generally include a modem, server, transceiver, and/or other device for communicating with other devices on a network. The network communication interface may be a communication interface having one or more communication devices configured to communicate with one or more other devices in the contactless payment environment 300, such as the mobile device 400, the workstation 550, the processing system 600, the remote coupon server 900, other processing systems, data systems, etc.

In one embodiment, the transceiver interface 515 is a separate module that may generally include a transceiver, i.e., one or more antennas and and/or other electronic circuitry, devices, and software, for receiving electronic payment vehicle and/or emulated coupon data when the mobile device is held close to or “tapped” at the contactless payment terminal. Data received by the processing device 520 may be used to execute the various process blocks of the contactless payment terminal, as described above with respect to FIGS. 1, 2, 3, and 4. In other embodiments, the transceiver interface 515 is part of the network communication interface 510. In some embodiments, the transceiver interface 515 may also be used an interface to send data to the mobile device 400 when the mobile device 400 is held close to or “tapped” at the contactless payment terminal.

An output device for the transceiver interface 515 may include a display that provides instructions regarding the steps for making a contactless payment. In some embodiments where the contactless payment terminal requests the user's signature, the display may also serve as a touchpad input device to input the user's signature via a stylus.

Other output devices may include one or more LEDs or an audio speaker, both which may indicate to the user that the data has been successfully received from the mobile device 400. A printer that can print paper receipts may also be incorporated into the contactless payment terminal. Other embodiments of the contactless payment terminal may carry other input and output devices, such as a mouse, keyboard, button, touchpad, touch screen, microphone, speaker, light, joystick, switch, or the like.

As used with respect to the contactless payment terminal 500, a “processing device,” such as the processing device 520, may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 520 may be configured to use the network communication interface 510 and/or the transceiver interface 515 to transmit and/or receive data and/or commands to and/or from the other devices that are visible in the contactless payment environment 300.

As used with respect to the contactless payment terminal 500, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein. In one embodiment, the memory device stores a transceiver application 555. The transceiver application 555 may work in conjunction with the previously described transceiver interface 515 to receive electronic payment vehicle data and/or emulated coupon data when the mobile device is held close to or “tapped” at the contactless payment terminal. In some embodiments, the transceiver application 555 may also be configured to send data to the mobile device when the mobile device is held close to or “tapped” at the contactless payment terminal.

As shown in FIG. 5, in some embodiments, a contactless payment terminal is connected to a workstation 550 via the network 150. The workstation 550 may be used by the cashier or other personnel to interact with the contactless payment terminal. The workstation 550 may include various features, such as a network communication interface, a processing device, a user interface, and a memory device.

As used with respect to the workstation 550, a “communication interface” may generally include a modem, server, transceiver, and/or other device for communicating with other devices on a network. The network communication interface may be a communication interface having one or more communication devices configured to communicate with one or more other devices on the network 350, such as the contactless payment terminal, the processing system, other processing systems, data systems, etc.

As used with respect to the workstation 550, a “processing device” may generally refer to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system may be allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device may be configured to use the network communication interface to transmit and/or receive data and/or commands to and/or from the other devices connected to the network 350.

As used with respect to the workstation 550, a “user interface” may generally include a plurality of interface devices and/or software that allow a user to input commands and data to direct the processing device to execute instructions. For example, the user interface may include a graphical user interface (GUI) or an interface to input computer-executable instructions that direct the processing device to carry out specific functions. The user interface may employ certain input and output devices to input data received from the user or the cashier or output data to the user or the cashier. These input and output devices may include a display, mouse, keyboard, button, touchpad, touch screen, microphone, speaker, light, joystick, switch, and/or other customer input/output device for communicating with one or more customers. As used with respect to the workstation 550, a “memory device” may generally refer to a device or combination of devices that store one or more forms of computer-readable media for storing data and/or computer-executable program code/instructions. For example, in one embodiment, the memory device may include any computer memory that provides an actual or virtual space to temporarily or permanently store data and/or commands provided to the processing device when it carries out its functions described herein.

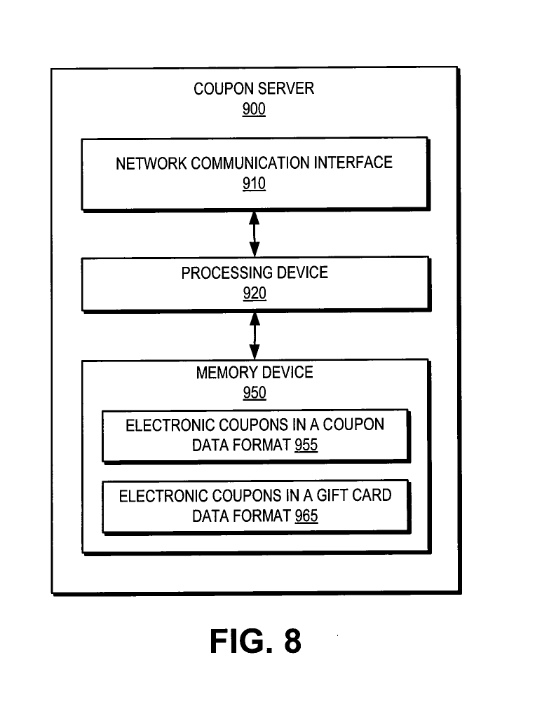

FIG. 8 illustrates an embodiment of the coupon server 900 illustrated in FIG. 5. Like the contactless payment terminal 500, the coupon server 900 includes a processing device 920 operatively coupled to a network communication interface 910 and a memory device 950. The network communication interface 910 allows the coupon server 900 to communicate with mobile devices 400 via the network 350 so that electronic coupons stored in the memory device 950 can be transmitted to a mobile device 400 and stored in the memory of the mobile device 400. As described above, in some embodiments of the invention, the coupon server 900 provides a mobile device 400 with electronic coupons in a coupon data format 955. However, in other embodiments of the invention described above, the coupon server 900 is configured to create electronic coupons using a gift card data format and transmit them to the mobile device 400 in the gift card data format.

Thus, present embodiments of the invention disclosed in detail above provide systems, methods, and computer program products for making and receiving payment at a contactless payment terminal using an electronic coupon that is emulated as an electronic gift card. As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is

1. An apparatus comprising:
a memory device comprising an electronic coupon stored therein;
a user interface configured to present information to a user;
a transmitter configured to wirelessly transmit information to a second apparatus; and
a processor operatively coupled to the memory device, the user interface, and the transmitter, wherein the processor is configured to:
present, using the user interface, the electronic coupon to the user as a coupon; and
transmit, using the transmitter, the electronic coupon to the second apparatus using a gift card data format.

2. The apparatus of claim 1, wherein the apparatus comprises a mobile device, wherein the second apparatus comprises a payment terminal, wherein the electronic coupon is stored in the memory device using a coupon data format, and wherein the processor is further configured to:
convert the electronic coupon from the coupon data format to the gift card data format.

3. The apparatus of claim 1, wherein the apparatus comprises a coupon server, wherein the second apparatus comprises a mobile device, and wherein the processor is further configured to:
create the electronic coupon using a gift card data format.

4. The apparatus of claim 1, wherein the apparatus comprises a mobile device, wherein the memory device comprises a plurality of electronic coupons stored therein, and wherein the processor is further configured to:
use the user interface to display the plurality of electronic coupons to the user and receive a user selection of the electronic coupon; and
emulate the electronic coupon using a gift card data format at least partially in response to receiving the user selection.

5. The apparatus of claim 4, wherein the second apparatus comprises a payment terminal, wherein the memory device comprises information about a plurality of payment vehicles stored therein, the wherein the processor is further configured to:
use the user interface to receive a user selection of a payment vehicle from the plurality of payment vehicles; and
at least partially in response to receiving the user selection of the payment vehicle, transmit information about the payment vehicle to the payment terminal.

6. The apparatus of claim 1, wherein the apparatus comprises a mobile device, wherein the second apparatus comprises a payment terminal, wherein the memory device comprises information about a payment vehicle stored therein, and wherein the processor is further configured to:
transmit, using the transmitter, the information about the payment vehicle to the payment terminal.

7. The apparatus of claim 1, wherein the apparatus comprises a mobile device, wherein the second apparatus comprises a payment terminal, and wherein the processor is further configured to:
emulate the electronic coupon using the gift card data format; and
transmit the emulated electronic coupon to the payment terminal in the gift card data format as a first data packet.

8. The apparatus of claim 7, wherein the memory device comprises information about a payment vehicle stored therein, and wherein the processor is further configured to:
transmit the information about the payment vehicle to the payment terminal as a second data packet after transmitting the first data packet to the payment terminal.

9. The apparatus of claim 7, wherein the processor is further configured to use the user interface to:
instruct the user to hold the mobile device close to the payment terminal a first time for transmission of the first data packet and a second time for transmission of the second data packet.

10. The apparatus of claim 7, wherein the memory device comprises information about a payment vehicle stored therein, and wherein the processor is further configured to:
transmit the information about the payment vehicle to the payment terminal as part of the first data packet.

11. A method comprising:
displaying an electronic coupon to a user as a coupon; and
transmitting, using a first apparatus, the electronic coupon to a second apparatus using a gift card data format.

12. The method of claim 11, wherein the first apparatus comprises a mobile device, and wherein the second apparatus comprises a payment terminal.

13. The method of claim 11, wherein the first apparatus comprises a coupon server, and wherein the second apparatus comprises a mobile device.

14. The method of claim 11, further comprising:
receiving the electronic coupon in a coupon data format; and
converting the electronic coupon from the coupon data format to the gift card data format.

15. The method of claim 11, further comprising:
transmitting, using the first apparatus, information about a payment vehicle to a second apparatus after transmitting the electronic coupon to the second apparatus.

16. The method of claim 11, further comprising:
transmitting, using the first apparatus, information about a payment vehicle to a second apparatus along with the electronic coupon.

17. A method of using a coupon during a transaction, the method comprising:
accessing an electronic coupon using a mobile device; and
using the mobile device to transmit the electronic coupon to a payment terminal as gift card data.

18. The method of claim 17, further comprising:
storing the electronic coupon in a memory of the mobile device in a coupon data format; and
using the mobile device to emulate the electronic coupon as gift card data.

19. The method of claim 17, further comprising:
accessing a payment vehicle using a mobile device;
waiting until the payment terminal has applied the electronic coupon to the transaction; and then
using the mobile device to transmit information about the payment vehicle to the payment terminal after the payment terminal has applied the electronic coupon to the transaction.

20. The method of claim 17, further comprising:
accessing a payment vehicle using a mobile device; and
using the mobile device to transmit information about the payment vehicle to the payment terminal along with the electronic coupon.

21. The method of claim 17, wherein accessing the electronic coupon using the mobile device comprises:
selecting an electronic coupon from a plurality of electronic coupons stored in the mobile device.

22. A method of receiving and applying a coupon to a transaction, the method comprising:
generating a first payment amount for the transaction;
wirelessly receiving a first data packet from a mobile device, wherein the first data packet comprises a coupon emulated as gift card data;
using the gift card data to apply the coupon to the transaction;
generating a second payment amount for the transaction after applying the coupon to the transaction;
wirelessly receiving a second data packet from the mobile device, wherein the second data packet comprises payment vehicle data; and
using the payment vehicle data to initiate payment for the second payment amount.

23. The method of claim 22, further comprising:
prompting a customer to hold the mobile device close to a payment terminal after the generating of the second payment amount.

24. The method of claim 22, wherein using the gift card data to apply the coupon to the transaction and generating the second payment amount comprises:
determining a percentage deductible amount based on the gift card data;
subtracting from the first payment amount the percentage deductible amount of the first payment amount.

25. A method of receiving and applying a coupon to a transaction, the method comprising:
generating a first payment amount for the transaction;
wirelessly receiving a data packet from a mobile device, wherein the data packet comprises a coupon emulated as gift card data;
in response to receiving the data packet, searching for gift card data in the data packet;
identifying the gift card data in the data packet;
processing the gift card data to generate a second payment amount that reflects application of the coupon to the transaction;
identifying payment vehicle data in the data packet;
processing the payment vehicle data to initiate payment for the second payment amount.

26. The method of claim 24 wherein identifying gift card data comprises identifying gift card protocol associated with the data packet.

27. A computer program product comprising a non-transitory computer-readable medium, the non-transitory computer-readable medium comprising computer-executable code portions stored therein, the computer-executable code portions comprising:
a code portion configured for displaying an electronic coupon to a user as a coupon; and
a code portion configured for transmitting, using a first apparatus, the electronic coupon to a second apparatus using a gift card data format.

28. The computer-program product of claim 27, wherein the first apparatus comprises a mobile device, and wherein the second apparatus comprises a payment terminal.

29. The computer-program product of claim 27, further comprising:
a code portion configured for receiving the electronic coupon in a coupon data format; and
a code portion configured for converting the electronic coupon from the coupon data format to the gift card data format.

30. The computer-program product of claim 27, further comprising:
a code portion configured for transmitting, using the first apparatus, information about a payment vehicle to a second apparatus after transmitting the electronic coupon to the second apparatus.
